(19) United States
(12) Patent Application Publication
(10) Pub. No.: US 2018/0373717 A1
(43) Pub. Date: Dec. 27, 2018

(54) METHODS AND APPARATUSES FOR PROCESSING BIOMETRIC RESPONSES TO MULTIMEDIA CONTENT

(71) Applicant: THOMSON Licensing, Issy-les-Moulineaux (FR)

(72) Inventors: Brian Charles ERIKSSON, San Jose, CA (US); Swayambhoo JAIN, Sunnyale, CA (US); Urvashi OSWAL, Madison, WI (US); Kevin Shuai XU, Toledo, OH (US)

(21) Appl. No.: 16/062,288

(22) PCT Filed: Dec. 16, 2015
(86) PCT No.: PCT/US2015/066138

§ 371 Date: Jun. 14, 2018

(51) Int. Cl. G06F 17/30; G06F 17/11

(52) U.S. Cl. CPC G06F 17/30032; G06F 17/11; G06F 17/30035; G06F 17/30843

(57) ABSTRACT

The present disclosure provides a method (500) and apparatus (1000, 250) for using the biometric responses of a first group of users watching and/or listening to digital multimedia content to generate a summary of the digital multimedia content by randomly selecting segments from the digital multimedia content as a function of segment scores determined from the biometric responses. In another method (600) and apparatus (1000, 250) of the present disclosure, the biometric responses of a second group of users being shown the generated summary of the digital multimedia content can be used to extrapolate the biometric responses of the second group of users to the entire digital multimedia content. Furthermore, yet another method (650) and apparatus (1000, 250) of the present disclosure can use the biometric responses of at least one user in the second group of users to generate recommendations.

### TECHNICAL FIELD

The present disclosure generally relates to the field of data analysis, and more particularly, to methods and apparatuses for processing biometric responses to digital multimedia content.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Assessing the reaction of viewers to digital multimedia content they consume is important for a wide variety of applications. Examples range from digital multimedia recommendation systems, where viewer ratings are used to profile their preferences, to market research, where content creators conduct surveys and focus groups with test audiences to predict the success of digital multimedia productions or ad campaigns.

While these applications traditionally utilize explicit feedback of user responses provided via ratings and survey forms, this feedback is often constrained by numerous factors. For example, existing movie recommendation systems request viewers to provide only a single rating for the entire movie, survey forms are limited by space and their reliance on viewer memory, and focus groups are constrained by participation costs and time limitations. These constraints make it difficult to achieve fine-grained viewer feedback about the digital multimedia content.

More recently, there has been adoption of wearable biometric sensors that monitor various biometric responses. Some examples of biometric responses that can be monitored by biometric sensors include, but are not limited to, heart rate, skin conductance, electroencephalography date, body temperature, brain wave activity, eye movement, pupil dilation, and electro dermal activity (EDA) signals. Wearable biometric sensors have enabled the capturing of viewer responses to digital multimedia content at much finer granularity than what explicit techniques allow for. Biometric sensors are increasingly being embedded in consumer electronic equipment like watches and fitness devices that continuously monitor the biometric responses of the user to the digital multimedia content. These biometric responses provide a rich source of implicit feedback which can be used to infer viewer reactions at various granularities.

Unfortunately, direct inference of viewer opinion of digital multimedia content using biometric responses is not straightforward and includes several challenges. For example, to perform market research using biometrics, viewers are gathered and shown content while wearing biometric sensors to record the biometric responses of the viewers. However, gathering or acquiring the biometric responses of users to lengthy digital multimedia content can be costly and time-consuming. Therefore, a need exists for more effective techniques to analyze and predict biometric responses to digital multimedia content. The present disclosure provides such a technique.

### SUMMARY

According to one aspect of the present disclosure, a method of generating a summary of a digital multimedia content is provided including receiving a plurality of biometric responses to the digital multimedia content for a plurality of users, the digital multimedia content including a plurality of samples, each biometric response in the plurality of biometric responses corresponding to a sample of the digital multimedia content and a user of the plurality of users, determining segment scores associated to a plurality of segments of the digital multimedia content based on the biometric responses of the plurality of users to corresponding segments, each segment corresponding to a subset of consecutive samples of the digital multimedia content, randomly selecting a number of segments based on the determined segment scores, and generating a summary of the digital multimedia content including the selected segments.

According to one aspect of the present disclosure, an apparatus for generating a summary of a digital multimedia content is provided, the apparatus including a processor, and at least one memory in communication with the processor, the processor being configured to receive a plurality of biometric responses to the digital multimedia content for a plurality of users, the digital multimedia content including a plurality of samples, each biometric response in the plurality of biometric responses corresponding to a sample of the digital multimedia content and a user of the plurality of users, determine segment scores associated to a plurality of segments of the digital multimedia content based on the biometric responses of the plurality of users to corresponding segments, each segment corresponding to a subset of consecutive samples of the digital multimedia content, randomly select a number of segments based on the determined segment scores, and generate a summary of the digital multimedia content including the selected segments.

According to one aspect of the present disclosure, a method of extrapolating user biometric responses to digital multimedia content is provided including receiving a first set of biometric responses to the digital multimedia content for a first group of users, the digital multimedia content including a plurality of samples, each biometric response in the first set of biometric responses corresponding to a sample of the digital multimedia content and a user of the first group of users, receiving a second set of biometric responses to a summary of the digital multimedia content for a second group of users, the summary of the digital multimedia content including a plurality of segments of the digital multimedia content, each segment corresponding to a subset of consecutive samples of the digital multimedia content, each biometric response of the second set of biometric responses corresponding to a sample in a segment of the summary of the digital multimedia content, and extrapolating biometric responses of the second group of users to the digital multimedia content based on the first set of biometric responses and the second set of biometric responses, the extrapolated biometric responses being other than the biometric responses in the second set.

According to one aspect of the present disclosure, an apparatus for extrapolating user biometric responses to digital multimedia content is provided, the apparatus including: a processor, and at least one memory in communication with the processor, the processor being configured to receive a first set of biometric responses to the digital multimedia content for a first group of users, the digital multimedia content including a plurality of samples, each biometric response in the first set of biometric responses corresponding to a sample of the digital multimedia content and a user of the first group of users, receive a second set of biometric responses to a summary of the digital multimedia content for a second group of users, the summary of the digital multimedia content including a plurality of segments of the digital multimedia content, each segment corresponding to a subset of consecutive samples of the digital multimedia content, each biometric response of the second set of biometric responses corresponding to a sample in a segment of the summary of the digital multimedia content, and extrapolate biometric responses of the second group of users to the digital multimedia content based on the first set of biometric responses and the second set of biometric responses, the extrapolated biometric responses being other than the biometric responses in the second set.

According to one aspect of the present disclosure, a method of providing a recommendation including receiving a set of biometric responses to digital multimedia content for at least one user including extrapolated biometric responses, generating a recommendation based on the biometric responses, and providing the recommendation.

According to one aspect of the present disclosure, an apparatus for providing a recommendation, the apparatus including a processor, and at least one memory in communication with the processor, the processor being configured to receive a set of biometric responses to digital multimedia content for at least one user including extrapolated biometric responses, generate a recommendation based on the biometric responses, and provide the recommendation.

### BRIEF DESCRIPTION OF THE DRAWINGS

These, and other aspects, features and advantages of the present disclosure will be described or become apparent from the following detailed description of the preferred embodiments, which is to be read in connection with the accompanying drawings.

FIG. 1A is an illustration of biometric responses stored in a matrix format in accordance with the present disclosure;

FIG. 1B is another illustration of biometric responses stored in a matrix format in accordance with the present disclosure;

FIG. 2 illustrates a block diagram of a system 200 in accordance with an embodiment of the present disclosure.

FIG. 3 is an illustration of an exemplary biometric sensor disposed on a hand in accordance with the present disclosure.

FIG. 4 is an illustration of another exemplary biometric sensor in accordance with the present disclosure.

FIG. 5 illustrates a flowchart of an exemplary method of generating a summary of digital multimedia content in accordance with the present disclosure.

FIG. 6A illustrates a flowchart of an exemplary method of extrapolating user biometric responses in accordance with the present disclosure.

FIG. 6B illustrates a flowchart of an exemplary method of providing a recommendation in accordance with the present disclosure.

FIG. 7A is a plot of the biometric responses of four users to an episode of a television show shown in accordance with an embodiment of the present disclosure.

FIG. 7B is a plot illustrating the low rank nature of an approximation in accordance with an embodiment of the present disclosure.

FIG. 8 illustrates the block leverage scores of a group of users to an episode of a television show in accordance with an embodiment of the present disclosure.

FIG. 9A illustrates the normalized Frobenius error of an approximation of the EDA responses of a group of users in accordance with an embodiment of the present disclosure.

FIG. 9B illustrates the normalized Frobenius error of an approximation of the EDA responses of a group of users in accordance with an embodiment of the present disclosure.

FIG. 9C illustrates the normalized Frobenius error of an approximation of the EDA responses of a group of users in accordance with an embodiment of the present disclosure.

FIG. 9D illustrates the normalized Frobenius error of an approximation of the EDA responses of a group of users in accordance with an embodiment of the present disclosure.

FIG. 10 illustrates a block diagram of a computing environment within which aspects of the present disclosure can be implemented and executed.

It should be understood that the drawing(s) are for purposes of illustrating the concepts of the disclosure and is not necessarily the only possible configuration for illustrating the disclosure.

### DESCRIPTION OF THE EMBODIMENTS

It also should be understood that the elements shown in the figures can be implemented in various forms of hardware, software or combinations thereof. Preferably, these elements are implemented in a combination of hardware and software on one or more appropriately programmed general-purpose devices, which can include a processor, memory and input/output interfaces. Herein, the phrase “coupled” is defined to mean directly connected to or indirectly connected with through one or more intermediate components. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (DSP) hardware, read only memory (ROM) for storing software, random access memory (RAM), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

The ability to perform large-scale data analysis, such as, for example, the analysis of biometric responses to digital multimedia content, is often limited by two opposing forces. The first force is the need to store observed data in a matrix format to use analysis techniques such as regression, classification or optimization. The second force is the inability to store most reasonably-sized real-world data matrices completely in memory due to size. This conflict gives rise to storing factorized matrix forms, such as Singular Value Decomposition (SVD) or CUR decompositions, as will be described in greater detail below.

A common problem in large-scale data analysis, such as, for example, the analysis of biometric responses to digital multimedia content, is approximating a matrix containing the biometric responses using a combination of specifically sampled rows and columns. For example, rows can represent individuals and columns can represent time, frames, or scenes of the digital multimedia content. Unfortunately, in many real-world environments, the ability to sample specific individual rows or columns of the matrix is limited by either system constraints or cost. In the present disclosure, a matrix approximation is considered where only predefined blocks of columns (or rows) can be sampled from the matrix. This has application in problems as diverse as hyper-spectral imaging, biometric data analysis, and distributed computing. The present disclosure provides a novel algorithm for sampling useful column blocks and provides worst-case bounds for the accuracy of the resulting matrix approximation. The algorithm considers both when the matrix is fully available and when only the sampled rows and columns of the matrix have been observed. The practical application of these algorithms is shown via experimental results using real-world user biometric data from a digital multimedia content testing environment, as will be described in greater detail below.

Initially, the present disclosure considers a matrix A with m rows and n columns, i.e., A ∈ R^{m×n}. Using a truncated k number of singular vectors (e.g., where k<min {m, n}), SVD provides the best rank-k approximation to the original matrix. In further detail, this calculates the k-singular column vectors and k-singular row vectors such that the linear combination of these two sets of vectors gives the best approximation of the original matrix A. Note that the singular vectors calculated can be arbitrary vectors of length n and m (for the row and column vectors respectively). The SVD singular vectors represent the original data of A in a rotated space and don't give a clear information or intuition of the underlying A, but simply the information that their linear combination can represent A. Hence, the difficulty of interpreting the singular vectors of an SVD, among other reasons, led to the introduction of the CUR decomposition, where the factorization is performed with respect to a subset of the rows and columns of the matrix itself. This specific decomposition describes the matrix A as the product of a subset of the matrix rows R and a subset of the matrix columns C along with a matrix U that fits to A.

$${[ \begin{matrix} & & \\ & A & \\ & & \end{matrix} ]}_{m \times n} \approx {{{[ \begin{matrix} & & \\ & C & \\ & & \end{matrix} ]}_{m \times c} [ \begin{matrix} & & \\ & U & \\ & & \end{matrix} ]}_{c \times r} [ \begin{matrix} & & \\ & R & \\ & & \end{matrix} ]}_{r \times n} \qquad ( 1 )$$

where m×c is the size of matrix C, c×r is the size of matrix U and r×n is the size of matrix R.

Previous work has examined how to efficiently choose the rows and columns in the CUR decomposition and derive worst-case error bounds. Unfortunately, a primary assumption of current CUR techniques, that individual rows and columns of the matrix can be queried, is either impossible or quite costly in many real-world problems. Some examples include:
Hyperspectral imaging, where m is the number of spectral channels, and n is the number of pixels. Acquisition time can be reduced considerably if, instead of a complete raster scan on the environment, only small spatial patches (i.e., blocks) are observed.
A matrix of biometric data collected from users reacting to external stimuli, e.g., watching video content. In this setting, m is the number of users and n is the number of time samples. Unfortunately, there is significant cost in acquiring each user's reaction to lengthy content. An individual time sample in this use case cannot be queried in isolation due to the lack of context that caused that biometric reaction. Instead, the present disclosure provides for presenting one or more users with collections of time segments (i.e., blocks), as will be described in greater detail below.
Distributed big data processing, where m is the number of records, and n is the number of attributes. By distributing data across multiple machines, there are distinct communication cost advantages to querying only a select number of machines containing collections of records (i.e., blocks).

According to the present disclosure, blocks of rows or columns are considered in the CUR matrix decomposition in order to overcome the problems described above. Hence, the CUR matrix decomposition of the present disclosure is hereby called Block CUR. In addition, a majority of prior CUR decomposition work makes the strong assumption that the data matrix A is known. In many applications, this matrix A is not known a priori; in fact, it is the primary reason that matrix approximation is being performed. The present disclosure considers both the case where A is known and where A is unknown a priori. When A is unknown a priori, the only knowledge of A is through the rows and columns that sampled in order to perform the Block CUR decomposition, as will be described in greater detail below.

Using these insights into real-world applications of CUR decomposition, the present disclosure provides several advantages over the prior art. For the case where the matrix is known, the present disclosure proposes a randomized CUR algorithm for subset selection of rows and blocks of columns and derives worst-case error bounds for this randomized algorithm. Furthermore, the present disclosure extends the randomized algorithm to the case where the matrix is unknown a priori and presents worst-case error bounds for this case. In addition, the present disclosure provides for approximating matrix multiplication and generalized l₂-regression in the block setting, as will be described in greater detail below.

The notation used in the present disclosure will now be described. In the present disclosure, Iₖ denotes the k×k identity matrix and 0 denotes a zero matrix of appropriate size. Furthermore, vectors are denoted by bold lowercase symbols, such as x, and matrices are denoted by bold uppercase symbols, such as X, where together, a vector and matrix will be denoted as x (X). Additionally, the i-th row (column) of a matrix is denoted by Xᵢ (Xⁱ). The i-th block of rows of a matrix by X₍ᵢ₎ and the i-th block of columns of a matrix by X⁽ⁱ⁾.

Let ρ=rank(A)≤min {m, n} and k≤ρ. The singular value decomposition (SVD) of A can be written as A=U_{A,ρ}Σ_{A,ρ}V_{A,ρ}^{T} where U_{A,ρ} ∈ [symbol] ^{m×ρ} contains the ρ left singular vectors; Σ_{A,ρ} ∈ [symbol] ^{ρ×ρ} is the diagonal matrix of singular values, σᵢ(A) for i=1 . . . , ρ; and V_{A,ρ}^{T} ∈ [symbol] ^{p×n} is an orthonormal matrix containing the ρ right singular vectors of A. We denote Aₖ=U_{A,k}Σ_{A,k}V_{A,k}^{T} as the best rank-k approximation to A. The pseudoinverse of A is defined as A^{†}=V_{A,ρ}Σ_{A,ρ}⁻¹U_{A,ρ}^{T}. It is to be appreciated that the pseudo-inverse of a m×n matrix A is a matrix that generalizes to arbitrary matrices the notion of inverse of a square, invertible matrix.

It is to be appreciated that the Frobenius norm and spectral norm of a matrix are denoted by ∥X∥_{F} and ∥X∥₂ respectively. The square of the Frobenius norm is computed by ∥X∥_{F}²=Σᵢ₌₁^{m}Σⱼ₌₁ⁿX_{i,j}²=Σᵢ₌₁^{k}σᵢ²(X). The spectral norm is given by ∥X∥₂=σₘₐₓ(X), where σₘₐₓ is the square root of the maximum eigenvalue of X^{H}X and X^{H} is the conjugate transpose of X.

CUR decomposition is focused on sampling rows and columns of a matrix to provide a factorization that is close to the best rank-k approximation of the chosen matrix. One of the most fundamental results for a CUR decomposition of a given matrix A ∈ [symbol] ^{m×n} is provided below in relation to Theorem 2.1:
Theorem 2.1. Given A ∈ [symbol] ^{m×n} and an integer k≤min {m, n}, let

$$c = O ( \frac{{k}^{2}}{{ɛ}^{2}} ln ( \frac{1}{δ} ) ) and r = O ( \frac{{c}^{2}}{{ɛ}^{2}} ln ( \frac{1}{δ} ) ) .$$

There exist randomized algorithms such that, if c columns are chosen to construct C and r rows are chosen to construct R, then with probability ≥1−δ, the following holds:

∥A−CUR∥_{F}≤(1+ε)∥A−Aₖ∥_{F} (2)
where ε, δ ∈ (0,1), and U=W^{†} is the pseudoinverse of the scaled intersection of C and R.

The randomized algorithm of Theorem 2.1 is obtained by sampling columns of the matrix A based on a “leverage score” that measures the contribution of each column to the rank-k approximation of A. The leverage score of a column is defined as the squared row norm of the top-k right singular vectors of A corresponding to the column:

lⱼ=∥V_{A,k}^{T}eⱼ∥₂²,j∈[n] (3)

where V_{A,k} is a n×k matrix consisting of the top-k right singular vectors of A as its columns, and eⱼ picks or selects the j-th column of V_{A,k}^{T}, the transpose of V_{A,k}. Therefore, the matrix V_{A,k} is a k×n matrix, eⱼ is a n×1 vector and V_{A,k}^{T}eⱼ is a k×1 vector. Moreover, eⱼ is defined as having a ‘1’ at row j ∈ [n] and ‘0’ at the remaining rows. Hence, the leverage score lⱼ is the spectral norm of the selected j-th column of V_{A,k}. According to one embodiment of the present disclosure, the leverage score can be described as an L2-norm of the selected j-th column of V_{A,k}^{T}, which is the sum of the squares of the components of the j-th column. It therefore represents the sum of the energy in the principal components (more specifically, the components of the right singular vectors) of the biometric responses corresponding to the j-th column of the digital multimedia content. According to another embodiment of the present disclosure, the leverage score can be described as an L1-norm of the j-th column, which is the sum of the absolute values of the components of the j-th column. According to yet another embodiment of the present disclosure, the leverage score can be described as an L0-norm of the j-th column, which is the sum of the values of the components of the j-th column. Other forms of norm can also be employed, e.g., p-norm.

The randomized algorithm involves randomly sampling the columns of A using probabilities generated by the calculated leverage scores to obtain the matrix C, and thereafter sampling the rows of A based on leverage scores generated by the left singular vectors of C to obtain R. Using such a random sampling mechanism, the randomized algorithm can achieve the accuracy outlined in Theorem 2.1.

It is to be appreciated that the columns sampled using subspace sampling or leverage scores lead to relative-error bounds. The leverage score of a column measures “how much” of the column lies in the subspace spanned by the top-k left singular vectors of A. By sampling columns that lie in this subspace more often, a relative-error low rank approximation of the matrix can be obtained.

In contrast to all known prior work, the present disclosure introduces block setting, where a block of columns is sampled rather than sampling a single column. The present disclosure extends the notion of subspace sampling to the block setting. Furthermore, the present disclosure gives relative error guarantees for CUR matrix decomposition in both the cases where the matrix is fully known and when it is a priori unknown, as will be described in greater detail below.

In accordance with the present disclosure, and without loss of generality, a block is defined as a collection of s contiguous columns. It is to be understood that, in some embodiments, different blocks can have different numbers of contiguous columns. It is also to be understood that, although the present disclosure defines a block as a collection of s contiguous columns, the teachings of the present disclosure also apply to blocks containing contiguous rows.

Let there be G=[n/s] possible blocks. The blocks are considered to be predefined due to natural constraints or cost. It is to be appreciated that one goal of the block CUR algorithm is to approximate the underlying matrix A using g blocks of columns and r rows, as represented below:

$${[ A ]}_{m \times n} \approx {{{[ {C}^{( 1 )} {C}^{( 2 )} … {C}^{( g )} ]}_{m \times gs} [ U ]}_{gs \times r} [ R ]}_{r \times n} \qquad ( 4 )$$

In accordance with the present disclosure, each block of columns selected is assigned a block leverage score. The block leverage score of a group of columns is defined as the sum of the squared row norms of the top-k right singular vectors of A corresponding to the columns in the block:

[symbol]

_{g}=∥V_{A,k}^{T}E_{g}∥_{F}²,g∈[G] (5)

where V_{A,k} is a n×k matrix consisting of the top-k right singular vectors of A as its columns, and E_{g} picks or selects the columns of V_{A,k}^{T} corresponding to the elements in block g. Therefore, the matrix V_{A,k}^{T} is a k×n matrix, E_{g} is a n×s vector and V_{A,k}^{T}E_{g} is a k×s vector, where s is the number of columns of block g. Moreover, each column of E_{g} addresses a column of V_{A,k}^{T} corresponding to an element in block g and is defined similarly to eⱼ in equation (3), where V_{A,k} consists of the top-k right singular vectors of A, and E_{g} picks or selects the columns V_{A,k}^{T} corresponding to the elements in block g. Hence, the block leverage score is the Frobenius norm of the selected columns of V_{A,k}^{T}, which is equivalent to the L2-norm, that is, the sum of the squares of the components of the columns of block g of V_{A,k}^{T}. It therefore represents the sum of the energy in the principal components (more specifically, components of the right singular vectors) of the biometric responses corresponding to the columns of the block g (or segment) of the digital multimedia content. Equivalently, the block leverage score represents the sum of the energy in the biometric responses to a given block or segment of the digital multimedia content after being projected onto the calculated right singular vectors of the corresponding matrix A of biometric responses. According to another embodiment, the block leverage score can be described as an L1-norm of the selected columns, which is the sum of the absolute values of the components of the columns of block g of V_{A,k}^{T}. According to yet another embodiment, the block leverage score can be described as an L0-norm of the components of the selected columns, which is the sum of the values of the components of the columns of block g of V_{A,k}^{T}. Other forms of norm can also be employed, e.g., p-norm.

The top-k right singular vectors V_{A,k} can be calculated when A is known. When there is no prior knowledge of A, these vectors must be estimated using the sampled rows and columns. As a result, the present disclosure separates results into two separate algorithms and theorems: (1) the case when the entire matrix A is known, and (2) the case when there is no prior knowledge of A.

Initially, the case where A is known will be explored, where Algorithm 1 is used to create a Block CUR approximation of A. Algorithm 1 takes as input the matrix A and returns as output an r×n matrix R consisting of a small number of rows of A and an m×c matrix C consisting of a small number of column blocks from A. Algorithm 1 is shown below:

Input: A, target rank k, size of each block s, error parameter ε, positive integers r, g

### Output: C, R, Â=CUR

1. Row subset selection. Sample r rows independently from A according to probability

$${p}_{i} = \frac{{‖ {U}_{A , k}^{T} {e}_{i} ‖}_{2}^{2}}{k}$$

for i ∈ [m] and compute R=S_{R}^{T}A, where S_{R} is an m×r matrix which selects the r sampled rows of A to generate R.
2. Column block subset selection: For t={1, 2, . . . g}, select a block of columns jₜ ∈ [G] independently with probability

$$Pr [ {j}_{t} = i ] = \frac{{‖ {V}_{R , r}^{T} {E}_{i} ‖}_{F}^{2}}{r}$$

for i ∈ [G] and update S, where S is an n×gs matrix which selects the gs sampled columns of A to generate C. Finally, compute C=AS.
3. CUR approximation: Â=CUR where U=W^{†}, and W=RS is the scaled intersection of R and C.

According to some embodiments of the present disclosure, pᵢ and/or Pr[jₜ=i] can be defined as a function of the L2-norm, L1-norm, L0-norm or other norms, e.g., p-norm, of the corresponding matrix products that they are based on, similarly to the embodiments of leverage score and block leverage score in equations (3) and (5).

In Algorithm 1, C=AS, where S ∈ [symbol] ^{n×gs} is the block scaling and sampling matrix and the jₜ, t-th non-zero s×s block of S is defined as:

$${S}_{{j}_{t} , t} = \frac{1}{\sqrt{{gp}_{{j}_{t}}}} {I}_{s} \qquad ( 6 )$$

where g=c/s is the number of blocks picked by the algorithm. An example of the sampling matrix S with blocks chosen in the order [1,3,2] is as follows:

$${S}_{n \times gs} = [ \begin{matrix}\frac{1}{\sqrt{{gp}_{1}}} {I}_{s} & 0 & 0 \\ 0 & 0 & \frac{1}{\sqrt{{gp}_{2}}} {I}_{s} \\ 0 & \frac{1}{\sqrt{{gp}_{3}}} {I}_{s} & 0 \\ 0 & 0 & 0\end{matrix} ] \qquad ( 7 )$$

This sampling matrix picks or selects the blocks of columns and scales each block to compute C=AS. A similar sampling and scaling matrix S_{R} is defined to pick the blocks of rows and scale each block to compute R=S_{R}^{T}A.

In Theorem 3.1, the present disclosure provides a relative-error guarantee for the approximation provided by Algorithm 1.
Theorem 3.1. Given A ∈ [symbol] ^{m×n}, let

$$r = O ( \frac{{k}^{2}}{{δ}^{4} {ɛ}^{2}} ) and g = O ( \frac{{r}^{2}}{{δ}^{4} {ɛ}^{2}} ) .$$

If rows and column blocks are chosen according to Algorithm 1, then with probability ≥1−δ, the following holds:

∥A−CUR∥_{F}≤(1+ε)∥A−Aₖ∥_{F} (8)
where ε, δ ∈ (0,1) and U=W^{†} is the pseudoinverse of the scaled intersection of C and R.

The result follows by writing C=AS and U=(RS)^{†} followed by applying Theorem 4.1 (as will be described below) for the column block selection.

To complete the Block CUR with known A case, a standard bagging technique is applied for randomized algorithms to get the following bound:
Theorem 3.2. Given A ∈ [symbol] ^{m×n}, let

$$r = O ( \frac{{k}^{2}}{{ɛ}^{2}} ln ( \frac{1}{{δ}_{t}} ) ) and g = O ( \frac{{r}^{2}}{{ɛ}^{2}} ln ( \frac{1}{{δ}_{t}} ) ) .$$

There exist randomized algorithms such that, if r rows and g column blocks are chosen to construct R and C, respectively, then with probability ≥1−δₜ, the following holds:

∥A−CUR∥_{F}≤(1+ε)∥A−Aₖ∥_{F} (9)
where ε, δ ∈ (0,1) and U=W^{†} is the pseudoinverse of the scaled intersection of C and R.

The result follows by fixing δ=0.3 in Theorem 3.1 and running Algorithm 1

$$t = ln ( \frac{1}{{δ}_{t}} )$$

times. By choosing the solution with minimum error and observing that 0.3<1/e, the relative error bound holds with probability greater than 1−e^{-t}=1−δₜ.

Theorems 3.1 and 3.2 are worst-case bounds, something that explains the absence of the dependence of group size on the sample complexity. For example, in the worst case, each group of columns can contain only one important column.

In Algorithm 1, the column block sampling is done using the right singular vectors of R. Instead, one can sample the column blocks based on the right singular vectors of A.

In many applications, the entire matrix A is not known. In these cases, algorithms requiring knowledge of the leverage scores cannot be used. Instead, the present disclosure introduces an estimate of the block leverage scores called the approximate block leverage scores. The row sampling distribution is chosen to be the uniform sampling distribution, and the block scores are calculated using the top-k right singular vectors of this row matrix. Below, Algorithm 2 is shown, where Algorithm 2 is used create an approximation of A only with the prior knowledge of a subset of rows and columns of A:

Input: target rank k, size of each block s, error parameter E, positive integers r, g

### Output: C, R, Â=CUR

1. Row subset selection: Sample r rows uniformly from A according to pᵢ=1/m for i ∈ [m] and compute R=S_{R}^{T}A where S_{R} is an m×r matrix which selects the r sampled rows of A to generate R.
2. Column block subset selection: For t={1, 2, . . . , g}, select a block of columns jₜ ∈ [G] with probability

$$Pr [ {j}_{t} = i ] = \frac{{‖ {V}_{R , r}^{T} {E}_{i} ‖}_{F}^{2}}{r}$$

for i ∈ [G] and update S, where S is an n×gs matrix which selects the gs sampled columns of A to generate C. Finally, compute C=AS.
3. CUR approximation: Â=CUR where U=W^{†} and W=RS is the scaled intersection of R and C.

According to one embodiment of the present disclosure, step 1 of Algorithm 2 can be represented by the rows of matrix A that are known, since they represent a form of sampling. Or additionally, sampling can be performed on the known rows.

According to some embodiments of the present disclosure, Pr[jₜ=i] can be defined as a function of the L2-norm, L1-norm, L0-norm or other norms, e.g., p-norm, of the corresponding matrix products that they are based on, similarly to the embodiments of block leverage score in equation (5).

It is to be appreciated that the running times of both Algorithms 1 and 2 are essentially driven by the time required to compute the SVD of A or R and the construction of R, C and U.

To approximate A when there is no prior knowledge of A, it is also necessary to define a notion of column space incoherence with respect to the unknown matrix A. This avoids pathological constructions of A that cannot be sampled at random. The top-k column space incoherence is defined as:

$$μ := μ ( {U}_{A , k}^{T} ) = \frac{m}{k} {max}_{i} {‖ {U}_{A , k}^{T} {e}_{i} ‖}_{2}^{2} \qquad ( 10 )$$

where eᵢ picks the i-th column of U_{A,k}^{T}.

The matrix inference error bounds for Block CUR without prior knowledge of A are shown below:
Theorem 3.3. Given A ∈ [symbol] ^{m×n} with incoherent top-k column space, i.e. μ≤μ₀, let

$$r = O ( {μ}_{0} \frac{{k}^{2} log ( k \text{/} δ )}{{δ}^{2} {ɛ}^{2}} ) and g = O ( \frac{{r}^{2} log ( r \text{/} δ )}{{δ}^{2} {ɛ}^{2}} ) .$$

If rows and column blocks are chosen according to Algorithm 2, then with probability ≥1−δ, the following holds:

∥A−CUR∥_{F}≤(1+ε)∥A−Aₖ∥_{F} (11)
where ε, δ ∈ (0,1) and U=W^{†} is the pseudoinverse of the scaled intersection of C and R.

By definition, U=(RS)^{†} and C=AS. The result follows by applying Theorem 4.1 (which will be described below) with sample complexity

$$g = O ( \frac{{r}^{2} log ( r \text{/} δ )}{{δ}^{2} {ɛ}^{2}} ) .$$

It is to be appreciated that the bagging procedure cannot be directly applied to get better bounds when A is not known a priori.

The incoherence assumption in Theorem 3.3 is used to provide a guarantee for approximation without access to the entire matrix A. If the entire matrix A is known, this information is leveraged to pick the “important” rows only and drop the incoherence assumptions (see Theorem 3.2).

It is to be appreciated that the CUR guarantee can be written as a special case of approximating generalized l₂ regression using block sampling as will be explained in greater detail below in relation to Theorem 4.1. The general result in Theorem 4.1 gives a guarantee on the approximate solution obtained by solving a subsampled regression problem instead of the entire regression problem. Approximating generalized l₂ regression in turn makes use of results on approximating matrix multiplication (as will be described below). The main observation is that the product of two matrices AB can be written as the sum of G rank-s matrices (the outer product of the blocks of columns of A and corresponding blocks of rows of B). Using matrix concentration inequalities (such as the matrix Bernstein inequality), the present disclosure shows that the matrix multiplication can be approximated by the sum of a subset of these outer products when sampled in a certain manner. It is important to note that the following results apply to sampling blocks of columns.

In this section, according to the present disclosure some mathematical derivations are provided for generalized least squares using block subset selection that is used to prove the main results for the algorithms but applies to arbitrary matrices A and B. Given matrices A ∈ [symbol] ^{m×n} and B ∈ [symbol] ^{r×n}, the generalized least squares problem is:

$${min}_{X ∈ {ℝ}^{m \times r}} {‖ A - XB ‖}_{F} \qquad ( 12 )$$

The solution to this optimization is given by \hat{X}=AB^{†}. To approximate this problem by a subsampled problem, some blocks of columns from A and B are sampled to approximate the standard l₂ regression by the following optimization:

$${min}_{X ∈ {ℝ}^{m \times r}} {‖ ( AS ) - X ( BS ) ‖}_{F} \qquad ( 13 )$$

The solution of this problem is given by \tilde{X}=AS(BS)^{†}. In Theorem 4.1, shown below, a guarantee is given stating that, when enough blocks are sampled with the specified probability, the approximate solution is close to the actual solution to the l₂ regression.
Theorem 4.1. Suppose B ∈ [symbol] ^{r×n} has rank no greater than k; A ∈ [symbol] ^{m×n}; ε, δ ∈ (0,1); and let the same column blocks from B and A be picked with the following probability distribution:

$${p}_{i} = \frac{{‖ {( {V}_{B , k} )}_{( i )} ‖}_{F}^{2}}{k} , ∀ i ∈ [ G ] \qquad ( 14 )$$

If

$$g = O ( \frac{{k}^{2} log ( k \text{/} δ )}{{δ}^{2} {ɛ}^{2}} ) or g = O ( \frac{{k}^{2}}{{δ}^{4} {ɛ}^{2}} )$$

blocks are chosen, then with probability at least 1−δ:

∥A−AS(BS)^{†}B∥_{F}≤(1+ε)∥A−AB^{†}B∥_{F} (15)

The crucial point to prove Theorem 4.1 is to show that V_{B,k}^{T} S is full rank where B=U_{B,k}Σ_{B,k}V_{B,k}^{T}, and S is the block sampling matrix. Using Lemma 4.1 and Lemma 4.2, as will be described below, the result is obtained.

Let A ∈ [symbol] ^{m×n} and B ∈ [symbol] ^{n×p}. Suppose scaled blocks of columns in A and the corresponding scaled blocks of rows in B are used to construct C and R. The matrix multiplication AB can be approximated by the product of the smaller sampled and scaled block matrices i.e.,

AB≈Σᵢ₌₁^{g}CᵢRᵢ (16)

More specifically, Lemma 4.1 is shown below:
Lemma 4.1. Approximating matrix multiplication: Let A ∈ [symbol] ^{m×n}, B ∈ [symbol] ^{n×p}, and ε, δ ∈ (0,1). Construct C and R using the sampling probabilities pᵢ given by:

$${p}_{i} \geq β \frac{{‖ {A}^{( i )} ‖}_{F} {‖ {B}_{( i )} ‖}_{F}}{{\sum }_{j = 1}^{G} {‖ {A}^{( j )} ‖}_{F} {‖ {B}_{( j )} ‖}_{F}} \qquad ( 17 )$$

for all i ∈ [G] and some constant β ∈ (0,1]. If

$$g \geq 2 ( \frac{1}{β} + 1 ) ( \frac{{‖ A ‖}_{F}^{2} {‖ B ‖}_{F}^{2}}{{psilon}^{2}} + \frac{{‖ A ‖}_{F} {‖ B ‖}_{F}}{3 ɛ} ) log ( \frac{m + p}{δ} ) ,$$

then, with probability at least 1−δ:

∥AB−CR∥₂≤ε (18)

In Lemma 4.2, shown below, a different probability distribution is used, where information regarding only one of the two matrices is used.
Lemma 4.2. Approximating matrix multiplication: Let A ∈ [symbol] ^{m×n}, B ∈ [symbol] ^{n×p}, and ε, δ ∈ (0,1). Construct C and R using the sampling probabilities pᵢ given by:

$${p}_{i} \geq β \frac{{‖ {A}^{( i )} ‖}_{F}^{2}}{{\sum }_{j = 1}^{G} {‖ {A}^{( j )} ‖}_{F}^{2}} \qquad ( 19 )$$

for all i ∈ [G] and some constant β ∈ (0,1]. Then, with probability at least 1−δ:

$${‖ AB - CR ‖}_{F} \leq \frac{1}{δ \sqrt{β g}} {‖ A ‖}_{F} {‖ B ‖}_{F} \qquad ( 20 )$$

There are many real-world applications for Algorithms 1 and 2, described above. One emerging application is audience reaction analysis of digital multimedia content using biometrics. For example, users watch video content while wearing sensors, with changes in biometric sensors indicating changes in reaction to the content. For example, increases in heart rate or a spike in electro dermal activity indicate an increase in content engagement. In prior work, biometric signal analysis techniques have been developed to determine valence (e.g., positive vs. negative reactions to films). Unfortunately, these experiments require a large number of users to sit through the entire video content, which can be both costly and time-consuming.

The present disclosure provides for implementations of the above described teachings for Block CUR decomposition in a method and apparatus for using the recorded biometric responses of a first group of users watching and/or listening to digital multimedia content, such as, but not limited to, video and/or audio content, text, pictures, drawings, etc., to determine the most relevant segments or blocks from the digital multimedia content. For example, the digital multimedia content can be a movie, a collection of TV commercials, a collection of photographs, a collection of songs, a collection of video clips, a radio program, a collection of drawings, a political speech, etc. The method and apparatus of the present disclosure can then automatically generate a short summary of the digital multimedia content including the most relevant segments from the digital multimedia content. The summary can be significantly shorter in length than the digital multimedia content. Additionally, in another method and apparatus of the present disclosure, the biometric responses of a second group of users being shown the generated summary of the digital multimedia content can be used to extrapolate the biometric responses of the second group of users to the entire digital multimedia content. The second group of users includes at least one user. Being able to extrapolate the biometric responses of a group of users, from showing the group of users a summary of the digital multimedia content, significantly reduces the costs associated with using biometric responses of users to digital multimedia content. Furthermore, yet another method and apparatus of the present disclosure can use the extrapolated biometric responses of the second group of users to generate recommendations for digital multimedia content.

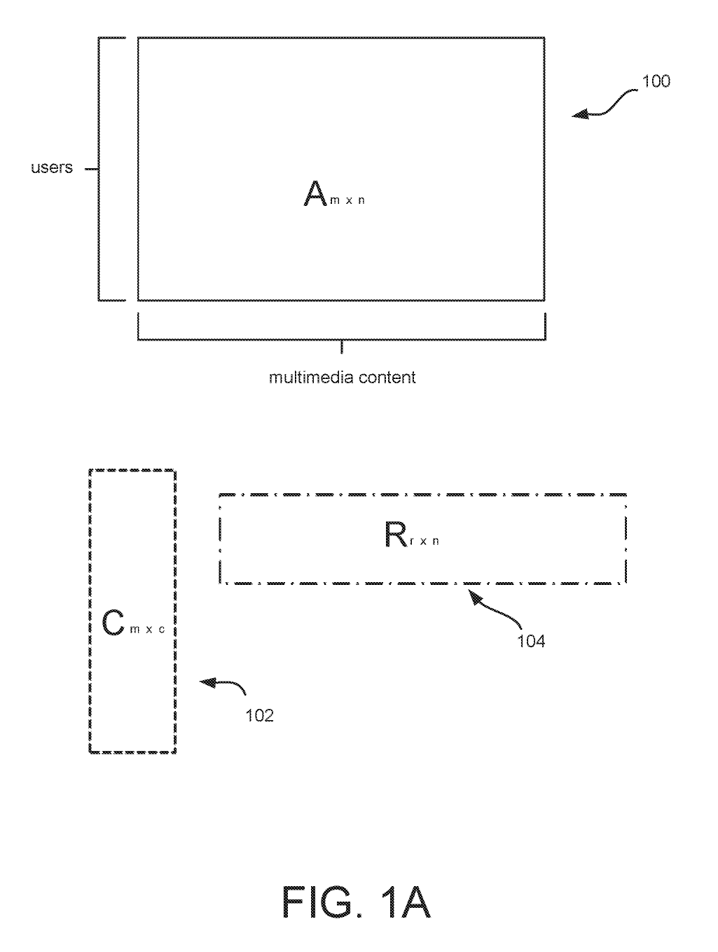

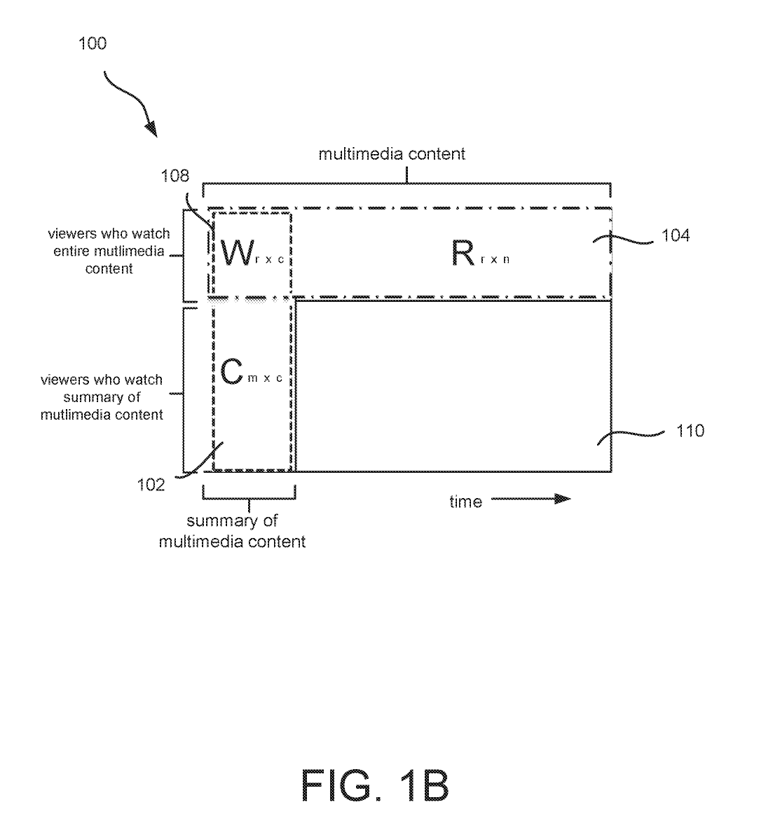

Referring to FIG. 1A, matrices 100, 102, and 104 are shown in accordance with the present disclosure. As described above, the biometric responses of a group of m users to a digital multimedia content including n time samples (i.e., time-instants in the digital multimedia content) can be recorded and stored in a matrix A, where in FIG. 1A, matrix A is represented by matrix 100. It is to be appreciated that each row of matrix A corresponds to the biometric responses of an individual user in the group of m users, and each column in matrix A corresponds to the biometric responses of the group of m users at a given point in time during the digital multimedia content. For example, in one embodiment, the group of m users is shown a movie and each user's biometric response is recorded for every 0.25 seconds of the movie shown. For example, for a two-hour movie, this represents 28800 biometric response samples per user. At the end of the movie, the recorded biometric responses of the group of m users is stored in a matrix A (i.e., matrix 100 shown in FIG. 1A). For example, for 1000 users, the matrix A has dimensions of 1000×28800. As stated above, it is both time intensive and an expensive task to store the individual biometric responses of a group of m users to a digital multimedia content including n time samples or time instants. For example, in a movie, a time sample represents a frame or picture; in a collection of drawings, a time sample represents one drawing. The present disclosure provides for a method and apparatus to reduce the time and cost of obtaining the biometric responses of the entire group of m users to a digital multimedia content.

In one embodiment of the present disclosure, only a subset of the group of m users is shown the entire digital multimedia content, for example, a movie. A group of r users is shown the entire digital multimedia content, where r<m, and the biometric responses of the group of r users are recorded and stored in a matrix R, where matrix R is matrix 104 in FIG. 1A. It is to be appreciated that each row in matrix R corresponds to the biometric responses of a user in the group of r users, and each column in matrix R corresponds to the biometric responses of the group of r users at a given point in time (or sample) out of n time instants (or samples) during the digital multimedia content. The biometric responses of the group of user's R can then be used to generate a summary of the digital multimedia content in accordance with the present disclosure, as will be described below. It is to be appreciated that the summary of the digital multimedia content is a collection of selected segments of the digital multimedia content, where the segments of the digital multimedia content correspond to a series of consecutive time instants out of n time instants (i.e., n columns in R) of the digital multimedia content.

The summary of the digital multimedia content can then be shown to the remaining users out of m users (i.e., m-r users) and the biometric responses of the remaining users can be recorded and stored in a matrix C, where matrix C is matrix 102 in FIG. 1A. Also stored in matrix C are the biometric responses of the users of group r to the summary of the digital multimedia content. It is to be appreciated that these biometric responses can be taken from matrix R. In this way, matrix C includes the biometric responses of all the users in the group of m users (i.e., group m) to the summary of the digital multimedia content. It is to be appreciated that each row of matrix C corresponds to the biometric responses of each user in group m at specific time instants out of n time instants. The specific time instants are the time instants selected in the summary of the digital multimedia. Each column of matrix C corresponds to the biometric responses of one of the users in group m at the specific time instants that are selected in the summary of the digital multimedia content.

Referring to FIG. 1B, matrix 100 is shown (i.e., matrix A), where matrix 100 includes matrix 102 (i.e., matrix C), matrix 104 (i.e., matrix R), matrix 108 (i.e., matrix W). It is to be appreciated that matrix W is the intersection of matrices C and R, i.e., matrix W includes the biometric responses of r users to the summary of the digital multimedia content. As will be described below in accordance with the present disclosure, matrices C, R, and W can be used to approximate the unknown portion of matrix A represented as section 110 of matrix A in FIG. 1B. It is to be appreciated that section 110 corresponds to the biometric responses of the group of users who only watched the summary of the digital multimedia content (i.e., m-r users) to remainder of the full or entire digital multimedia content (i.e., to the parts of the digital multimedia content they did not see, which are the parts not in the summary).

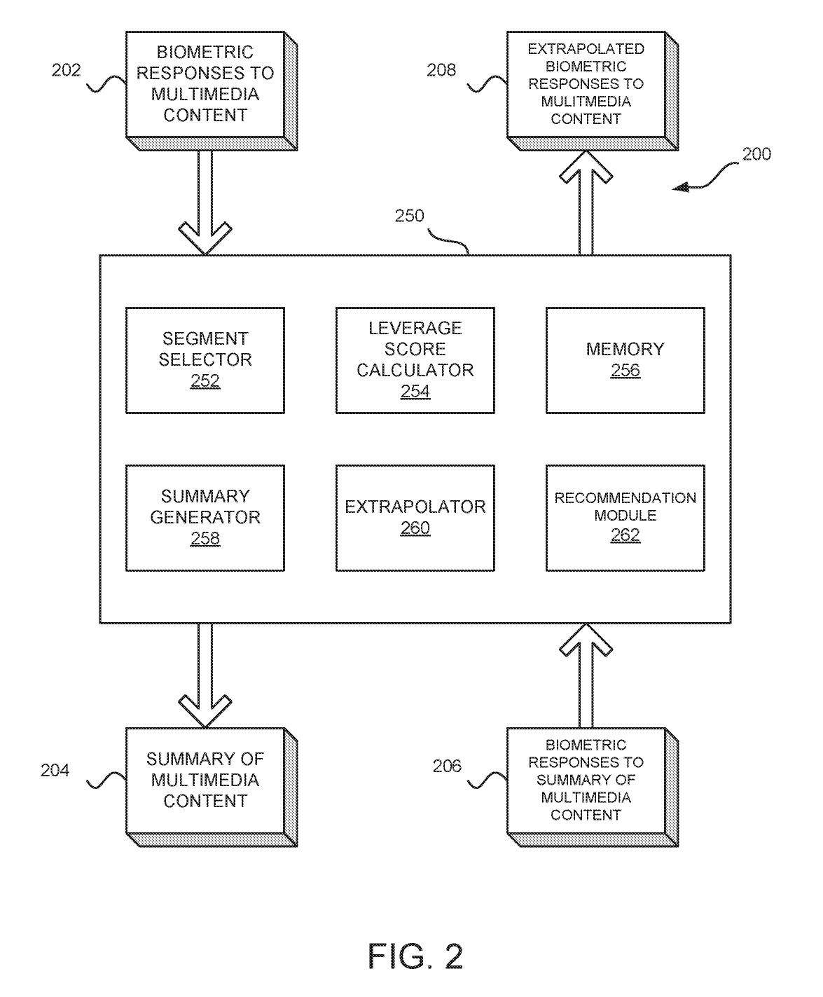

Referring to FIG. 2, an exemplary system 200 is shown in accordance with an embodiment of the present disclosure. The system 200 includes biometric response analyzer 250, where biometric response analyzer 250 can be configured to receive the biometric responses 202 of a first group of users (i.e., group of users r, as described above) shown a particular digital multimedia content and to produce a summary 204 of the digital multimedia content. Furthermore, the biometric response analyzer 250 can be configured to receive the biometric responses 206 of a second group of users (i.e., the group of m-r users described above) shown the summary 204 of the digital multimedia and to extrapolate or predict the biometric responses 208 of the second group to the full digital multimedia content shown to the first group. In this way, biometric response analyzer 250 can predict the biometric responses the second group would have had if the second group had been shown the full digital multimedia content. Also, biometric response analyzer 250 can be configured to make digital multimedia content recommendations to users based on a user's biometric response to a summary of a digital multimedia content, as will be described in greater detail below.

Biometric response analyzer 250 includes segment selector 252, leverage score calculator 254, memory 256, summary generator 258, extrapolator 260, and recommendation generator module 262. Memory device 256 can be a at least one of a transitory memory such as Random Access Memory (RAM), a non-transitory memory such as a Read-Only Memory (ROM), a hard drive, and/or a flash memory, for processing and storing different files and information as necessary, including, user interface information, databases, etc. It is to be appreciated that the biometric response analyzer 250 of the present disclosure can be implemented in hardware, software, firmware, or any combinations thereof. In some embodiments, the biometric response analyzer 250 can be implemented in software or firmware that is stored on a memory device (e.g., a RAM, ROM, hard drive or flash memory device) and that is executable by a suitable instruction execution system (e.g., a processing device). In some embodiments, the various modules (e.g., module 252, 254, 256, 258, 260) can be implemented in hardware using, for example, discrete logic circuitry, an application specific integrated circuit (ASIC), a programmable gate array (PGA), a field programmable gate array (FPGA), or any combinations thereof. In some embodiments, only some of the functionalities of the biometric response analyzer 250 can be implemented, therefore, requiring only some of the modules. For example, in order to generate the summary 204, from the biometric responses 202, only the modules segment selector 252, leverage score calculator 254 and summary generator 258 can be implemented. In another example, in order to generate the extrapolated biometric responses 208 from the biometric responses to summary 206, only the module extrapolator 260 can be implemented. For example, in order to generate the recommendation, only the recommendation generator module 262 can be implemented.

As stated above, biometric response analyzer 250 can be configured to receive biometric responses 202 of a first group of users (i.e., group r) to a digital multimedia content, such as, but not limited to, a video and/or audio content. It is to be appreciated that, the biometric responses 202 of the first group of users (group r) is stacked and sorted in the form of a matrix by biometric response analyzer 250. For example, the biometric responses 202 of the first group of users (group r) are stored in a matrix R, where the rows of R correspond to the number of users (r) and the columns of R correspond to the recorded biometric time instant or samples (n) of each user (r). It is to be appreciated that the biometric responses can be measured with one of many biometric sensors.

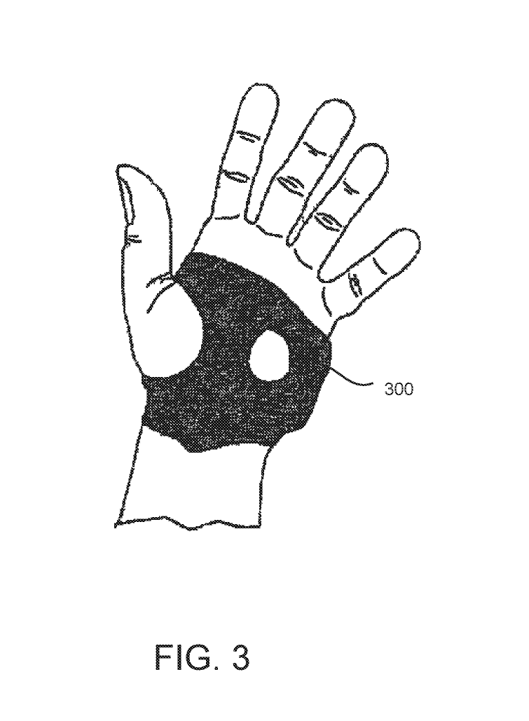

For example, referring to FIG. 3, an exemplary biometric sensor 300 is shown in accordance with the present disclosure. Biometric sensor 300 is an EDA sensor suitable for use with biometric response analyzer 250, described above. It is to be appreciated that although biometric sensor 300 is an EDA sensor, any one of a plurality of available biometric sensors that measure a variety of physiological human responses can be used with biometric response analyzer 250. For example, biometric sensors measuring heart rate and accelerometer data can also be used. In one embodiment, biometric sensor 300 can be a commercially available EDA sensor similar to one sold by Affectiva, Altham, Mass. which a user can wear on their palms, as shown in FIG. 3.

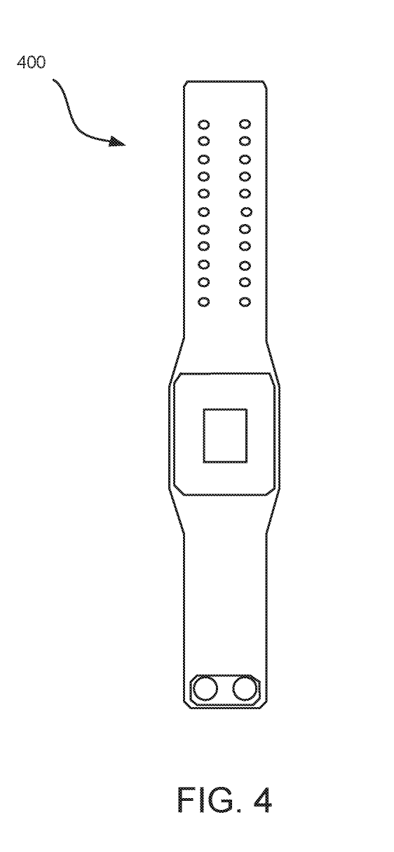

As another example, a biometric sensor can be worn around the user's wrist. Referring to FIG. 4, an exemplary biometric sensor 400 is shown in accordance with the present disclosure. Biometric sensor 400 is a wearable wireless multi-sensor device for real-time biometric and data acquisition suitable for use with biometric response analyzer 250. Biometric sensor 400 has four embedded sensors: photoplethysmograph (PPG), EDA, 3-axis accelerometer, and temperature. In one embodiment, biometric sensor 400 can be a commercially available multi-sensor device similar to one sold by Empatica, Inc., which a user can wear around their wrist.

It is to be appreciated that biometric sensors 300, 400 are both configured to record the biometric responses of users who are listening to and/or watching digital multimedia content. In one embodiment, the biometric responses to digital multimedia content are stored on a memory in biometric sensor 300 or 400 (not shown), and later sent to biometric response analyzer 250, where the responses can be stored in a memory 256 in biometric response analyzer 250. In an alternative embodiment, biometric sensors 300 and 400 are configured to stream any recorded biometric responses to biometric response analyzer 250 over a wireless network, where the biometric responses can be stored in memory 256 for later use. In yet another embodiment, the biometric responses to digital multimedia content from biometric sensor 300 or 400 are stored on a non-transitory memory (not shown), and the biometric response analyzer 250 later accesses the non-transitory memory (e.g., Compact Disk (CD) or Digital Versatile Disk (DVD)) to obtain the biometric responses. It is to be understood that there are many other ways to transfer the biometric responses from biometric sensor 300 or 400 to biometric response analyzer 250 which are well-known to a person skilled in the art of data collection, storage and access.

As an example, a first group of users wearing biometric sensors 300 or 400 can be shown a digital multimedia content, such as a motion picture. The biometric sensors 300 or 400 can record the biometric responses 202 of the first group of users to the digital multimedia content and send the biometric responses 202 to biometric response analyzer 250. It is to be appreciated that the biometric responses can be recorded in any desired time interval. For example, the biometric responses can be recorded multiple times per second, or every second, or every 25 seconds. Once the biometric responses 202 have been recorded, the biometric responses 202 are sent to biometric response analyzer 250, where they can be stored in a matrix format (i.e., matrix R), as described above. In one embodiment, the biometric responses can be sent to, accessed by, or received by biometric response analyzer 250 already in a matrix format. Then, leverage score calculator 254 in biometric response analyzer 250 can be configured to calculate a leverage score associated with each user's biometric response to different segments (i.e., corresponding to blocks of columns in the data matrix R) of the digital multimedia content. These leverage scores are the “block leverages scores” (i.e., [symbol] _{g}) or segment scores calculated as described above in the present disclosure, in item 2 (Column block subset selection) of algorithm 1 or 2, and derived from equation (5). The blocks considered here are continuous collections of columns in matrix R with respect to time, with the block size being a parameter of the system 200 to be tuned.

It is to be appreciated that the number of rows to be sampled (i.e., the number of users, r, chosen to be in the first group), the size of the blocks (i.e., the number of consecutive time instants, s, including the segments of the digital multimedia content that will be used to generate the summary), and the number of blocks (i.e., the number of segments, g, used to generate the summary) can be tuned based on the time and cost desired to be incurred in gathering and storing the data along with the desired accuracy of the biometric response approximations. Furthermore, the block size or size of the segments of the digital multimedia content must be sufficiently large that the second group of users will have enough context from the chosen segments to elicit accurate reactions. The larger the first group is (i.e., the more the number of rows, r, of matrix A are sampled), the more accurate the approximation will be. Furthermore, the larger the block size (i.e., the more time instants, s, in the segments in the summary) and the more blocks chosen (i.e., the more segments, g, used in the summary), the more accurate the approximation will be. Theorem 3.3, described above, gives values for s, g and r, which describe the minimum size and number of groups and rows needed. However, s, g and/or r can be increased as desired to produce more accurate approximations.

It is to be appreciated that the block leverage scores (or segment scores) can be calculated by leverage score calculator 254 using a heuristic that depends on the collected biometric responses from each user in the first group of users. For example, in one embodiment, a biometric sensor, such as, biometric sensor 300 or 400, can be used to sense the galvanic skin response (GSR) of each user in the first group of users at various time intervals out of n time intervals, while the user is watching and/or listening to the digital multimedia content. Leverage score calculator 254 can be configured to calculate the block leverage scores of each column block associated with the observed user's biometric response to various segments of the digital multimedia content. In one embodiment, the block leverage score can be based on the sum of the energy in the biometric (e.g., GSR) responses to a given segment of the digital multimedia content. In another embodiment, the block leverage score can be based on the sum of the energy in the biometric (e.g., GSR) responses to a given segment of the digital multimedia content after being projected onto the calculated right singular vectors similarly to equation (5). It is to be appreciated that although the above described embodiment uses GSR, many other forms of biometric data can be used in accordance with the present disclosure to determine the block leverage scores.

It is to be appreciated that the digital multimedia content shown to the first group of users can be stored in memory 256. Segment selector 252 can be configured to randomly select a predetermined or chosen number of segments (i.e., blocks of columns) of the digital multimedia content based on the block leverage scores determined by leverage score calculator 254. Segment selector 252 can use the block leverage scores to determine the probability (i.e., Pr as calculated above in step 2 of algorithm 1 or 2) that a segment is chosen, such that blocks with higher block leverage scores are more likely to be chosen, while blocks with lower block leverage scores are less likely to be chosen. It is to be appreciated that this random selection can be performed using one of many distribution sampling techniques, such as, but not limited to, the Metropolis-Hastings algorithm. After segment selector 252 randomly selects segments of the digital multimedia content shown to the first group of users, summary generator 258 can be configured to extract the segments selected by segment selector 252 from the digital multimedia content (which can be stored in memory 256) and to generate a summary 204 of the digital multimedia content (including the selected segments of the digital multimedia content) shown to the first group of users. In one embodiment, summary generator 258 can be configured to provide the summary 204 of the digital multimedia content to another device, e.g., a display device or a storage device, internal or external to biometric response analyzer 250.

It is to be appreciated that the segments of the digital multimedia content in the summary 204 can be organized chronologically according to each segment's position in the original digital multimedia content. For example, in one embodiment segment selector 252 randomly selects a first segment, a second segment, and a third segment of a digital multimedia content according to a probability of each segment, as described above, where the first segment occurs at the middle of the digital multimedia content, the second segment occurs during the end of the digital multimedia content, and the third segment occurs at the beginning of the digital multimedia content. Summary generator 258 can be configured to order the selected segments in the same order in which they originally appear in the digital multimedia content prior to generating the summary 204, such that the third segment is at the beginning of the summary, the first segment is in the middle of the summary, and the second segment is at the end of the summary. In one embodiment, summary generator 258 can be configured to generate the summary 204 in the same order of selection or random sampling, that is, first, second and third segments, in this order.

It is to be appreciated that in one embodiment of the present disclosure, the length of at least some of the segments (i.e., the duration of time in the digital multimedia content or the block size in the matrix R) can be chosen such that one or more segments are shorter than the scene corresponding to the segment in the digital multimedia content. A scene in a film is defined generally as an action in a single location/setting of the digital multimedia content occurring continuously in time. For example, in one embodiment a segment chosen to be part of the summary of the digital multimedia content is a portion of a car chase scene. The segment need not be the whole car chase scene, but can be a subset of it. Additionally, a selected segment can contain portions of two different scenes. For example, a selected segment can be chosen such that a portion of the selected segment is at the end of one scene in the digital multimedia content, while another portion of the selected segment is at the beginning of a second scene in the digital multimedia content.

Furthermore, it is to be appreciated that the segments selected for the summary of the digital multimedia content can be chosen such that, at least some of the selected segments are of different lengths (i.e., differing durations of time in the digital multimedia content). For example, one selected segment can be 15 seconds long, while another selected segment can be 30 second long, etc. In another embodiment of the present disclosure, all segments selected for the summary of the digital multimedia content are the same length.

The summary 204 of the digital multimedia content shown to the first group of users (i.e., group r) can later be shown to a second group of users (i.e., m-r) while the second group of users each wears a biometric sensor, for example, biometric sensor 300 or 400 described above and shown in FIGS. 3 and 4. The biometric responses 206 of the second group of users to the summary 204 can then be sent to biometric response analyzer 250 and stored in a matrix format (i.e., matrix C), as described above. Or, in an alternate embodiment, the data of the matrix C can be directly sent to other modules of the biometric response analyzer 250. It is to be appreciated that biometric response analyzer 250 can also be configured to extract the biometric responses of the first group of users to segments corresponding to the summary of the digital multimedia content and add the extracted biometric responses to the matrix C, as described above. In this way, matrix C contains the biometric responses of both the first and the second group of users to the segments including the summary of the digital multimedia content. It is also to be appreciated that biometric response analyzer 250 can access or receive a previously stored matrix C from a non-transitory memory. It is to be understood that the second group of users includes at least one user.

Furthermore, biometric response analyzer 250 can be configured such that, the biometric responses 206 of the second group of users to the summary 204 of the digital multimedia content can be used to extrapolate the biometric responses the second group of users would have had, if the second group of users had watched the full digital multimedia content shown to the first group of users (i.e., the unknown portion 110 of matrix A, as described above, can be extrapolated or estimated). Specifically, when biometric response analyzer 250 receives the biometric responses 206 of the second group of users to the summary 204, i.e., matrix C, extrapolator 260 can determine the intersection between the biometric responses of the first users to the full digital multimedia content (i.e., matrix R) and the biometric responses of the second users to the summary of the digital multimedia content (i.e., matrix C), where the intersection is the biometric responses of the first group of users to the segments of the digital multimedia content including the summary of the digital multimedia content (i.e., matrix W). Based on each user's biometric response 206 in the second group of users to the summary and the biometric responses 202 of the first group of users to the entire digital multimedia content, extrapolator 260 can determine approximately how at least one user in the second group of users would respond to seeing the full digital multimedia content (i.e., extrapolator 260 can determine the product of matrices C, U, and R in that order, where matrix U is the pseudoinverse of matrix W, as described above). It is to be appreciated that extrapolator 260 can be configured to calculate the pseudoinverse of matrix W The extrapolated matrix (i.e., the approximation of matrix A including the biometric responses of the first and second group of users to the entire digital multimedia content) can then be provided, or stored in memory 256 to be later retrieved. In one embodiment, the biometric response analyzer 250 can just provide the biometric responses of the second group of users to the remainder of the full digital multimedia content (i.e., the portion of the content not watched by the second group). According to the present disclosure, providing can be outputting to a storage device, e.g., non-transitory memory, or to another device, e.g., a display device.

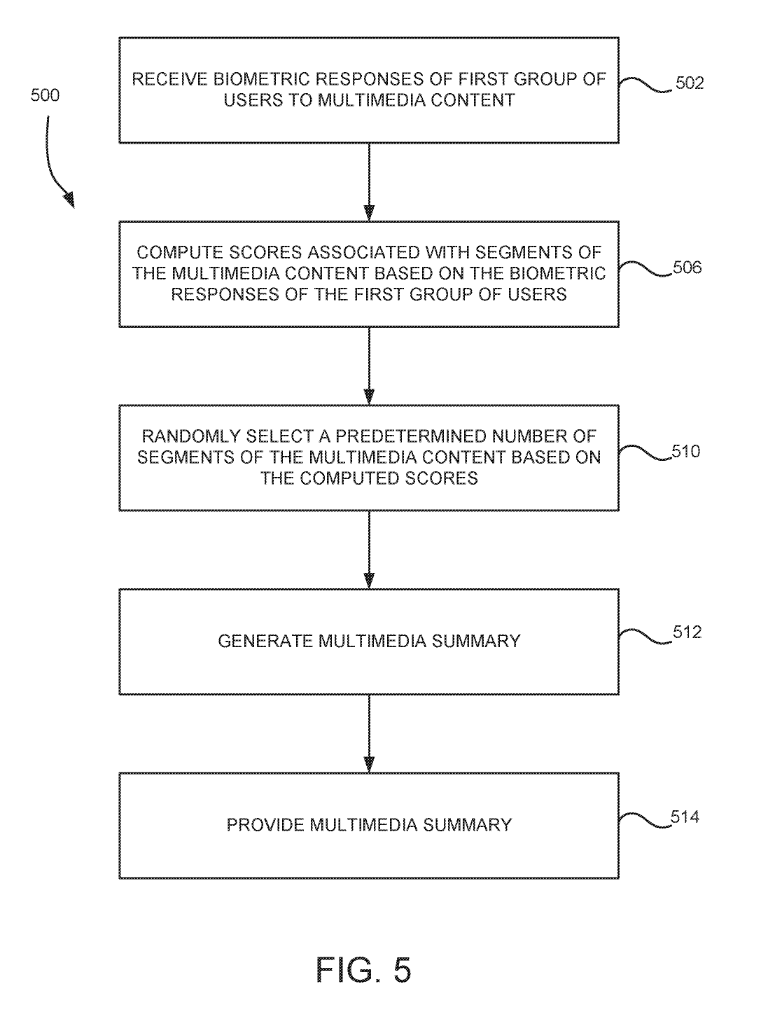

Referring to FIG. 5, an exemplary method 500 for generating a summary of a digital multimedia content based on the measured biometric responses of a first group of users is shown in accordance with the present disclosure.

Initially, the biometric responses of a first group of users (i.e., group r) to digital multimedia content are received, in step 502. It is to be appreciated, that, as stated above, the size of the first group of users (i.e., group r) can be chosen as desired based on the desired accuracy of the approximations and the costs associated with obtaining the data. The biometric responses of the first group of users to the digital multimedia content can then be stored in a first matrix (i.e., matrix R), where each row of the first matrix corresponds to a user of the first group of users and each column of the matrix corresponds to a time sample of the digital multimedia content. The step of storing can also be skipped in some implementations of the method where storing the first matrix is not necessary, e.g., streamlined or pipelined implementations. Then, the block leverage scores (i.e., Pr as calculated above in any of the embodiments of Algorithm 2) are computed for the segments (i.e., blocks of columns of predetermined or chosen size, as described above, of matrix R) of the digital multimedia content based on the biometric responses of a first group of users, in step 506. Since each segment includes a number of columns of matrix R, the corresponding biometric responses for the columns of a segment are associated with the segment including the columns. It is to be appreciated, as stated above, that the length of each of the segments is (i.e., number of columns or time instants in a block) such that a user watching and/or listening to a segment can still discern the context of the chosen segment within the digital multimedia content. In one embodiment, the length is the same for each segment. In another embodiment, the length can vary from segment to segment. Furthermore, the length of each of the segments is chosen as guided by cost and desired accuracy. Once the block leverage scores for the segments of the digital multimedia content are calculated, a predetermined number of segments of the digital multimedia content will be randomly selected based on the computed scores, in step 510. It is to be appreciated that, in some embodiments, the segments of the digital multimedia content are randomly selected without replacement to eliminate the possibility of selecting the same segment from the digital multimedia content twice. Then, the selected segments are combined to generate a summary for the digital multimedia content, in step 512. Finally, the generated summary for the digital multimedia content can be provided, in step 514, The step of providing can include outputting to a storage device (e.g., a non-transitory memory), or outputting to another device, e.g., a display device.

It is to be appreciated that the summary of the digital multimedia content can have utility associated with collection of user/viewer reaction to content, for market or scientific research, e.g., in the movie or TV industry, advertisement in various industries, political campaigns, brain research for psychological or artificial intelligence purposes, etc.

It is to be appreciated that method 500 can be used with biometric response analyzer 250 and biometric sensor 300 or 400. For example, in one embodiment, the biometric responses of the first group of users to a digital multimedia content can be recorded using biometric sensor 300 or 400 and the biometric responses of a first group of users to the digital multimedia content can be received by biometric response analyzer 250, in step 502. Biometric response analyzer 250 can then store the biometric responses of the first group of users to the digital multimedia content in a first matrix (i.e., matrix R, as described above). It is to be appreciated that the first matrix can be stored in memory 256. Or, in an alternate embodiment, the data of the first matrix can be directly sent to other modules of the biometric response analyzer 250. Then, leverage score calculator 254 can compute the block leverage scores of the blocks of columns (corresponding to segments in the digital multimedia content) in the first matrix, in step 506. It is to be appreciated, as described above, that the size of the blocks of columns can be tuned as desired. The block leverage scores computed by leverage score calculator 254 can then be sent to segment selector 252, where segment selector 252 can randomly selects a predetermined or chosen number of segments of the digital multimedia content (where the digital multimedia content can be stored in memory 256, as described above) based on a probability calculated for each block of columns in the first matrix corresponding to a segment, in step 510. It is to be appreciated that, the calculated probability of a block of columns in the first matrix is proportional to the block leverage score calculated for that block, where segments corresponding to blocks with higher block leverage scores are more likely to be selected by segment selector 252. After segment selector 252 has randomly selected a predetermined number of segments of the digital multimedia content, summary generator 258 can retrieve the selected segments from the digital multimedia content stored in memory 256 to generate a summary 204 of the digital multimedia content, where the summary 204 includes the selected segments, in step 512. Finally, the biometric response analyzer 250 provides the summary 204, which can include outputting to a storage device (e.g., a non-transitory memory), or outputting to another device, e.g., a display device.

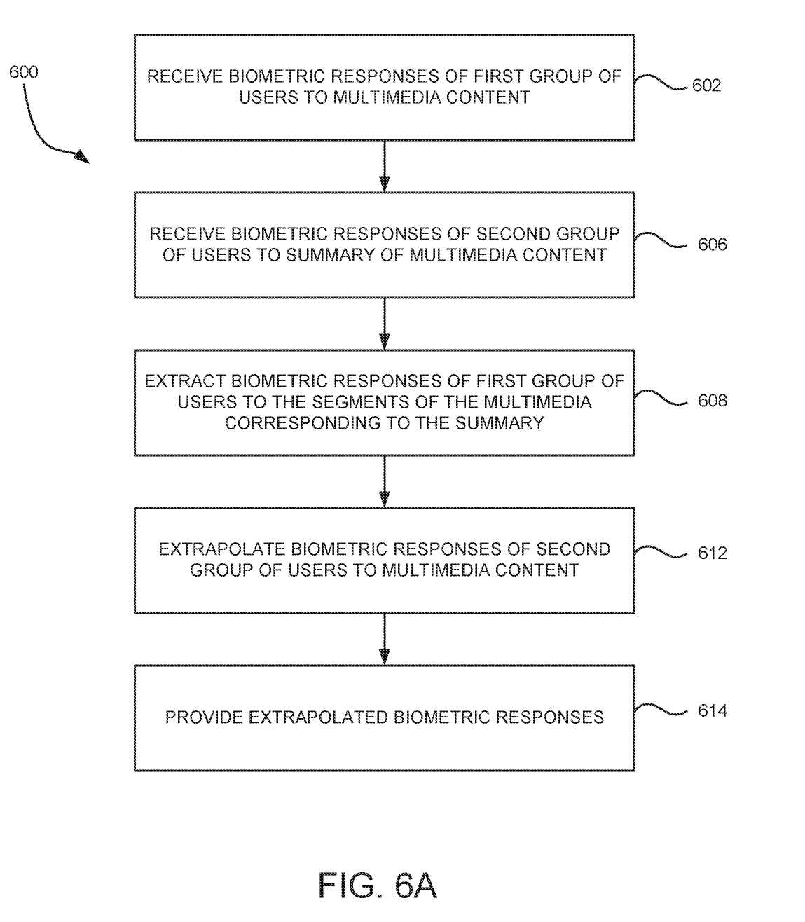

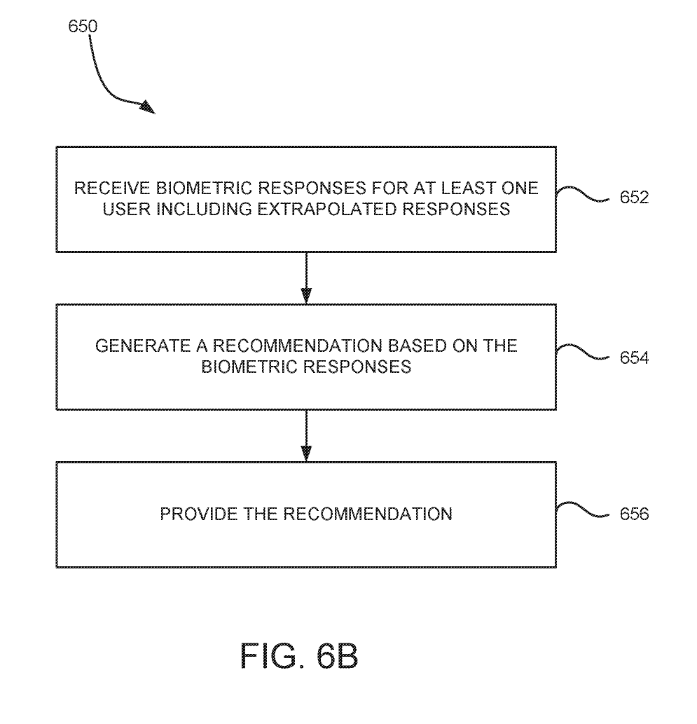

Referring to FIG. 6A, an exemplary method 600 of extrapolating the biometric responses of a second group of users to a digital multimedia content based on the biometric responses of the second group to the summary of the digital multimedia content generated in step 512 of method 500 is shown in accordance with the present disclosure.

Initially, a first set of biometric responses of a first group of users (i.e., group r) to a digital multimedia content is received, in step 602. The biometric responses of the first group of users to the digital multimedia content can then be stored in a first matrix (i.e., matrix R), where each row of the first matrix corresponds to a user of the first group of users and each column of the matrix corresponds to a time instant of the digital multimedia content. The step of storing matrix R can also be skipped in some embodiments of the method where storing the first matrix is not necessary, e.g., streamlined or pipelined implementations. Then, a second set of biometric responses of a second group of users (i.e., group m-r) to a summary of the digital multimedia content shown to the first group of users (i.e., the summary generated in step 512) is received, in step 606. The second group of users includes at least one user. Once received, the biometric responses of the first group of users to the segments of the digital multimedia content corresponding to the summary can be extracted from the first matrix, in step 608. Then, the extracted biometric responses of the first group of users to the segments of the digital multimedia content corresponding to the summary and the biometric responses of the second group of users to the summary can be stored in a second matrix (i.e., matrix C as described above and shown in FIGS. 1A-B). The step of storing matrix C can also be skipped in some implementations of the method where storing the second matrix is not necessary, e.g., streamlined or pipelined implementations. It is to be appreciated that, as described above, the intersecting portions of the first matrix and the second matrix form a third matrix (i.e., matrix W). Based on the biometric responses of the first group of users the digital multimedia content and the biometric responses of the second group of the users to the summary of the digital multimedia content, the biometric responses of the second group of users to the segments of the digital multimedia content, other than the segments of the digital multimedia content in the summary (i.e., the segments of the digital multimedia content the second group of users did not watch and/or listen to), are extrapolated, in step 612. It is to be appreciated that the extrapolated responses in step 612 can be determined by calculating the product of the second matrix (i.e., matrix C), the pseudoinverse of the third matrix (i.e., matrix U), and the first matrix (i.e., matrix R), in that order, to estimate the extrapolated matrix A corresponding to the full response to the digital multimedia content (including the known responses received by the method and the extrapolated biometric responses). Finally, the method 600 can provide, in step 614, the extrapolated biometric responses of the second group of users. In one embodiment, the method can provide the estimated full response of the second group of users. In another embodiment, the method 600 can provide the extrapolated matrix A. The step of providing can include outputting to a storage device (e.g., a non-transitory memory), or outputting to another device, e.g., a display device.

It is to be appreciated that method 600 can be used with biometric response analyzer 250 and biometric sensor 300 or 400. For example, in one embodiment, the biometric responses of the first group of users to a digital multimedia content can be recorded using biometric sensor 300 or 400 and the biometric responses of a first group of users to the digital multimedia content can be received by biometric response analyzer 250, in step 602. Biometric response analyzer 250 can then store the biometric responses of the first group of users to the digital multimedia content in a first matrix (i.e., matrix R, as described above). It is to be appreciated that the first matrix can be stored in memory 256. Or, in an alternate embodiment, the data of the first matrix can be directly sent to other modules of the biometric response analyzer 250. Then, the biometric responses of a second group of users (i.e., group m-r) to a summary of the digital multimedia content shown to the first group of users (i.e., the summary generated in step 512) can be received by biometric response analyzer 250, in step 606. Once received, the biometric responses of the first group of users to the segments of the digital multimedia content corresponding to the summary can be extracted from the first matrix by extrapolator 260, in step 608. Then, the extracted biometric responses of the first group of users to the segments of the digital multimedia content corresponding to the summary and the biometric responses of the second group of users to the summary can be stored in a second matrix by extrapolator 260 (i.e., matrix C as described above and shown in FIGS. 1A-B). It is to be appreciated that the second matrix can be stored in memory 256 of biometric response analyzer 250. Or, in an alternate embodiment, the data of the second matrix can be directly sent to other modules of the biometric response analyzer 250. It is also to be appreciated that, as described above, the intersecting portions of the first matrix and the second matrix form a third matrix (i.e., matrix W), where the third matrix can also be stored in memory 256. Or, in an alternate embodiment, the data of the third matrix can be directly sent to other modules of the biometric response analyzer 250 or provided as an output. Based on the biometric responses of the first group of users to the digital multimedia content and the biometric responses of the second group of the users to the summary of the digital multimedia content, the biometric responses of the second group of users to the segments of the digital multimedia content, other than the segments of the digital multimedia content in the summary (i.e., the segments of the digital multimedia content the second group of users did not watch and/or listen to), can be extrapolated by extrapolator 260, in step 612. It is to be appreciated that the extrapolated biometric responses in step 612 can be determined by extrapolator 260 by calculating the product of the second matrix (i.e., matrix C), the pseudoinverse of the third matrix (i.e., matrix U), and the first matrix (i.e., matrix R), in that order. Furthermore, it is to be appreciated that the extrapolated biometric responses can be stored in memory 256. In another embodiment, the extrapolated biometric responses can be directly provided without internal storage in memory 256. Finally, the biometric response analyzer 250 provides the extrapolated biometric responses 208, which can include outputting to a storage device (e.g., a non-transitory memory), or outputting to another device, e.g., a display device. In one embodiment, the biometric response analyzer 250 can provide the estimated full response of the second group of users. In another embodiment, the biometric response analyzer 250 can provide the extrapolated matrix A.

It is to be appreciated that although the embodiments above have been described as being used with video content, biometric response analyzer 250 and methods 500 and 600 can be used with many other types of digital multimedia content as well. For example, in one embodiment, digital multimedia content shown to the first group of users (as described above in reference to biometric response analyzer 250 and methods 500 and 600) can be used with audio content, such as songs, audiobooks, lectures, etc. The audio content can be played for a first group of users wearing a biometric sensor, such as biometric sensors 300 or 400, and the biometric responses of the first group of users to the audio content can be recorded and stored in a first matrix (i.e., matrix R), as described above. Then, a summary of the audio content can be generated (i.e., step 510 of method 500). The biometric responses of a second group of users wearing biometric sensors (such as biometric sensors 300 or 400) to the summary of the audio content can be recorded and stored in a second matrix (i.e., matrix C). Then, the biometric responses of the first group of users to the audio content and the biometric responses of the second group of users to the summary of the audio content can be used to extrapolate the biometric responses of the second group of users to the segments of the audio content that the second group of users has not listened to (i.e., step 612 of method 600).

Furthermore, although continuous digital multimedia content (i.e., continuous video and audio) is described as being used above in reference to biometric response analyzer 250 and methods 500 and 600, biometric response analyzer 250 and methods 500 and 600 can also be used with digital multimedia content that is discrete in nature, such as, but not limited to, a collection of photographs, a series of presentation slides, etc. For example, a first group of users wearing biometric sensors, such as biometric sensors 300 or 400, can be shown a collection of photographs, where the photographs are shown individually, at a predetermined rate, to the first group of users. The biometric responses of the first group of users to being shown the collection of photographs can then be recorded in a first matrix (i.e., matrix R), where as described above, the rows of the first matrix correspond to the users in the first group of users, and each of the columns corresponds to the biometric responses of each user to an individual photograph. In this way, the collection of photographs can be separated into segments and block leverage scores (as described above) can be calculated for the segments corresponding to the block of columns in the first matrix (i.e., a block corresponding to a subset of the entire collection of photographs). As described above, based on the block leverage scores and a probability calculated, segments (i.e., subsets of photographs within the collection of photographs) can be randomly selected to generate a summary of the collection of photographs, where the summary of the collection of photographs can be significantly shorter (i.e., includes less photographs) than the entire collection of photographs). The summary can then be shown to a second group of users wearing biometric sensors, and the biometric responses of the second group of users can be recorded in a second matrix (i.e., matrix C). Then the biometric responses of the second group of users to the photographs in the collection of photographs that were not included in the summary of the collection of photographs can be extrapolated based on the biometric responses of the first group of users to the collection of photographs and the biometric responses of the second group of users to the summary of the collection of photographs.

Referring again to FIG. 2, it is to be appreciated that biometric response analyzer 250 can include recommendation generator module 262, where recommendation generator module 262 is configured to make digital multimedia content recommendations based the biometric responses of a user to a summary of the digital multimedia content or to estimated digital multimedia content including extrapolated biometric responses. It is to be appreciated that the summary of the digital multimedia content or the extrapolated biometric responses to the digital multimedia content can be generated as described above in reference to biometric response analyzer 250 and method 500. For example, in one embodiment, the biometric responses of a user in the second group of users to the summary of the multimedia content can be received by recommendation generator module 262. In another embodiment, the extrapolated biometric responses 208 can be received by recommendation generator module 262. Then, recommendation generator module 262 can be configured, for example, to determine whether a user likes, or finds one or more segments of the digital multimedia content, or even the entire digital multimedia content, exciting. Recommendation generator module 262 can also be configured, for example, to determine whether one or more segments of the digital multimedia content, or even the entire digital multimedia content, are exciting to general users. Recommendation generator module 262 can be further configured, for example, to determine whether one or more users are excitable individuals, that is, individuals who react more strongly to stimulus than others, versus non-excitable persons, that is, persons who react less strongly than others. A user's reaction in terms of excitement or engagement, versus indifference or lack of interest can be detected by general biometrics sensors. These kinds of reactions are of value to scientific and market research, in order to understand how the human brain works, and to understand how to market to different individuals.

In one embodiment, extrapolator 260 can extrapolate the biometric responses of a user in the second group of users to the segments of the digital multimedia summary that the user did not watch or listen to (as described above in method 600 and in reference to biometric response analyzer 250). Then, recommendation generator module 262 can calculate a recommendation score of the biometric responses (e.g., the sum of the energy in the GSR of the biometric responses of the user, the sum of the absolute values of the GSR of the biometric responses of the user, etc.) for a segment in the digital multimedia content that the user did not watch or listen to (i.e., a segment not in the summary of the digital multimedia content) and if recommendation generator module 262 determines that the function is above a predetermined or chosen threshold, then recommendation generator module 262 can recommend that the user would have found that segment exciting if the user had watched or listened to it. Alternatively, if recommendation generator module 262 determines that the function is below a predetermined threshold, then recommendation generator module 262 can recommend that the user would not have found that segment exciting if the user had watched or listened to it. It is to be appreciated that recommendation generator module 262 can also determine if the user finds a segment that the user did watch or listen to exciting in the same way described above.

In another embodiment, recommendation generator module 262 can be further configured to determine if the user will find a group of segments of the digital multimedia content exciting based on the user's biometric responses to the summary of the digital multimedia content. For example, after extrapolator 260 has extrapolated the biometric responses of the user to the entire multimedia content (as described above), recommendation generator module 262 can calculate the recommendation score of the user for a group of segments in the digital multimedia content. It is to be appreciated that any combination of segments of the digital multimedia content can be chosen so that recommendation generator module 262 can determine a recommendation. It is to be appreciated that the group of segments can be segments that occurred consecutively within the digital multimedia content (for example, the group of segment can include a scene of the digital multimedia content), or the segments can be segments from different portions of the digital multimedia content. For example, the group of segment can include one segment from the beginning of the digital multimedia content, another segment from the middle of the digital multimedia content, and another segment from the end of the digital multimedia content. Furthermore, it is to be appreciated that some or all of the segments of the group of segment can be segments of the digital multimedia content that the user did not watch or listen to. If the recommendation generator module 262 determines that the recommendation score of the user is above a predetermined threshold, then recommendation generator module 262 can recommend that the user would have found the group of segments exciting (or did find that group exciting, if the group of segments only includes segment the user watched or listened to) if the user had watched or listened to it. Alternatively, if the recommendation generator module 262 determines that the recommendation score of the user is below a predetermined threshold, then recommendation generator module 262 will recommend that the user would not have found the group of segments exciting (or did not find that group exciting, if the group of segments only includes segment the user watched or listened to) if the user had watched or listened to it.

In yet another embodiment, the recommendation generator module 262 can take the biometric responses of the user to the entire digital multimedia content (i.e., the biometric responses to the summary and the biometric responses extrapolated by extrapolator 260) and determine whether the user finds the entire digital multimedia content exciting. For example, the recommendation generator module 262 can calculate the recommendation score of the user for the entire digital multimedia content to determine whether the recommendation score is above or below a predetermined threshold. Similarly to the embodiments above, if recommendation generator module 262 determines that the recommendation score is above the predetermined threshold, the recommendation generator module 262 will recommend that the user would find the digital multimedia content exciting if the user where to watch it. Alternatively, recommendation generator module 262 will recommend that the user would not find the digital multimedia content exciting if the sum is below the predetermined threshold.

It is to be appreciated that although it is described above that recommendation generator module 262 can determine recommendation for one user based on the user's biometric responses to a summary of a digital multimedia content, recommendation generator module 262 is also configured such that it can determine recommendation for an entire group of users, for example, the entire second group of users as described above.

It is to be appreciated that the recommendation score of the biometric responses can be a linear or nonlinear function and is not limited to a sum of squares, or a sum of absolute values of the biometric responses. It is to be appreciated that although the GSR is described as being used in the embodiments above, many other types of biometric data can be used by recommendation generator module 262. If other types of biometric data are used, recommendation generator module 262 can be configured to calculate the recommendation score of the value of the other types of biometric data to determine the recommendations. It is to be appreciated that the choice of a threshold for a particular type of recommendation can be obtained from experimentation or training, prior to generating the recommendations. For example, some use cases can be run to determine in general, the threshold value for a recommendation on whether movies of a certain genre are or not exciting to people. For example, an action movie generally elicits stronger reactions from people than a romantic comedy; therefore, the thresholds for these two movies may not be the same.

In this way, the recommendation generator module 262 can be configured such that, recommendation generator module 262 can make recommendations to a user or a group of users about one or more segments in a digital multimedia content based on the biometric responses of the user or group of users to a summary of a multimedia content, even if the user or group of users has not watched or listened to one or more segments of the digital multimedia content.

Additionally, the teachings of the present disclosure can be used in audience segmentation and clustering, determining members of the audience who respond in similar ways. For example, in another embodiment, the recommendation generator module 262 can be configured to be used to make recommendations on what products (e.g., other digital multimedia content items, cars, clothes, sports events) a user may like based on the biometric responses of a user to a summary of a digital multimedia content or to the estimated multimedia content including extrapolated biometric responses. For example, in one embodiment, the biometric responses of a plurality of users to a plurality of summaries of digital multimedia content items are stored in memory 256 of biometric response analyzer 250. Then, the biometric responses of a user A, where user A is not in the plurality of users, to a summary of a digital multimedia content B are recorded. Recommendation generator module 262 can be configured to search memory 256 to find clusters of users in the plurality of users that responded similarly to user A to summary B. Then, recommendation generator module 262 can determine what digital multimedia contents the identified cluster of users liked in a similar genre (i.e., action, thriller, educational, etc.) and suggest that user A also watch and/or listen to the suggested digital multimedia contents that the cluster of users also liked. Recommendation generator module 262 can also suggest other products to user A, based on other products that the identified cluster of users like (e.g., cars, shoes, books, sports events, etc.).

Referring to FIG. 6B, an exemplary method 650 of providing a recommendation is shown in accordance with the present disclosure.

Initially, at step 652, the method 650 includes receiving a set of biometric responses to digital multimedia content for at least one user, the set of biometric responses including extrapolated biometric responses 208 generated according to flowchart 600. Then, at step 654, the method includes generating a recommendation based on the biometric responses. Finally, at step 656, the method includes providing the recommendation.

According to one embodiment of the method 650, the step of generating further includes determining a recommendation score based on the set of biometric responses, and determining a recommendation based on the recommendation score. The recommendation score can be a linear or nonlinear function of the biometric responses.

According to one embodiment of the method 650, the step of determining a recommendation score further includes determining a sum of the energy of the biometric responses of the at least one user to at least one segment in the digital multimedia content. It is to be understood that the sum of the energy of the biometric responses can imply the sum of the squared values of the biometric responses.

According to one embodiment of the method 650, the step of determining a recommendation score further includes determining a sum of the absolute value of the biometric responses of the at least one user to at least one segment in the digital multimedia content.

According to one embodiment of the method 650, the step of determining a recommendation score further includes determining a sum of the biometric responses of the at least one user to at least one segment in the digital multimedia content.

According to one embodiment of the method 650, the step of determining a recommendation further includes determining that the at least one segment is exciting if the recommendation score is above a content threshold and that the at least one segment is not exciting if the recommendation score is below the content threshold. In one embodiment, the user threshold is a function of the personality or type of user. It is to be understood that a content threshold is a value that can be selected based on prior experiments. For example, test cases can be run to identify general levels of biometric responses of users for a number of different multimedia content items, in order to establish the most likely values of a content threshold for a type of user or for a group of users.

According to one embodiment of the method 650, the step of determining a recommendation further includes determining that the at least one user is excitable if the recommendation score is above a user threshold and that the at least one user is not excitable if the recommendation score is below the user threshold. In one embodiment, the user threshold is a function of the genre or type of digital multimedia content. For example, a user may be excitable for a genre of movies and not for another. It is to be understood that a user threshold is a value that can be selected based on prior experiments. For example, test cases can be run to identify general levels of biometric responses of users for a number of different multimedia content items, in order to establish the most likely values of a user threshold for each type or genre of digital multimedia content, or for a group of genres on digital multimedia content.

According to one embodiment of the method 650, the step of generating a recommendation further includes determining a rating for the multimedia content based on whether the at least one segment is exciting, wherein the rating is the recommendation. The rating can be proportional to the recommendation score associated with the at least one segment. For example, a rating of 0 to 5 can be given, where a recommendation score close to the content threshold receives a value of 3. Hence, values of 4 and 5 are above the content threshold and indicative of above average to excellent ratings, and values of 0 to 2 are below the threshold, and indicative of poor to less than average ratings.

According to one embodiment of the method 650, the step of generating a recommendation further includes determining at least one product to recommend to one user among the at least one user based on whether the one user is excitable, wherein the at least one product is the recommendation. The product(s) can be determined based on general likes and dislikes of users with similar recommendation scores to the one user. The product(s) can also be determined based on general likes and dislikes of users with similar biometric responses to the one user. The similarity of the biometric responses can be measured with the Euclidean distance between the respective biometric responses of any two users or groups of users. Other types of distance can also be used, e.g., Hamming distance, Bhattacharya distance, etc. A distance threshold can be compared against to identify sets of similar versus dissimilar biometric responses. For example, an excitable user may be more likely to plan a trip to Alaska. A non-excitable user may be more likely to read a book.

According to one embodiment of the method 650, the step of generating a recommendation further includes determining at least one product to recommend to one user among the at least one user, based on whether the one user has similar biometric responses to other users among the at least one user, wherein the at least one product is the recommendation. The product(s) can be determined based on general likes and dislikes of the other users. The similarity of the biometric responses can be measured with the Euclidean distance between the respective biometric responses of any two users or groups of users. Other types of distance can also be used, e.g., Hamming distance, Bhattacharya distance, etc. A distance threshold can be compared against to identify sets of similar versus dissimilar biometric responses.

It is to be understood that recommendation generator module 262 of biometric response analyzer 250 can be configured to perform any of the embodiments of the method in flowchart 650. In addition, any of the embodiments of recommendation generator module 262 is also an embodiment of the method in flowchart 650.

The experimental results of applying Block CUR decomposition described above to users watching an episode of a television show are hereby described in accordance with the present disclosure. The biometric experiment setup is as follows. An Empatica E3 wearable, such as, biometric sensor 300, was attached to 24 users (i.e., a group of m users) to measure EDA at 4 Hz. The 24 users were shown a 41-minute episode of the television series “NCIS”, in the genres of action and crime. The resulting biometric data matrix (i.e., matrix A) was 24×9929, where m=24 and n=9929.

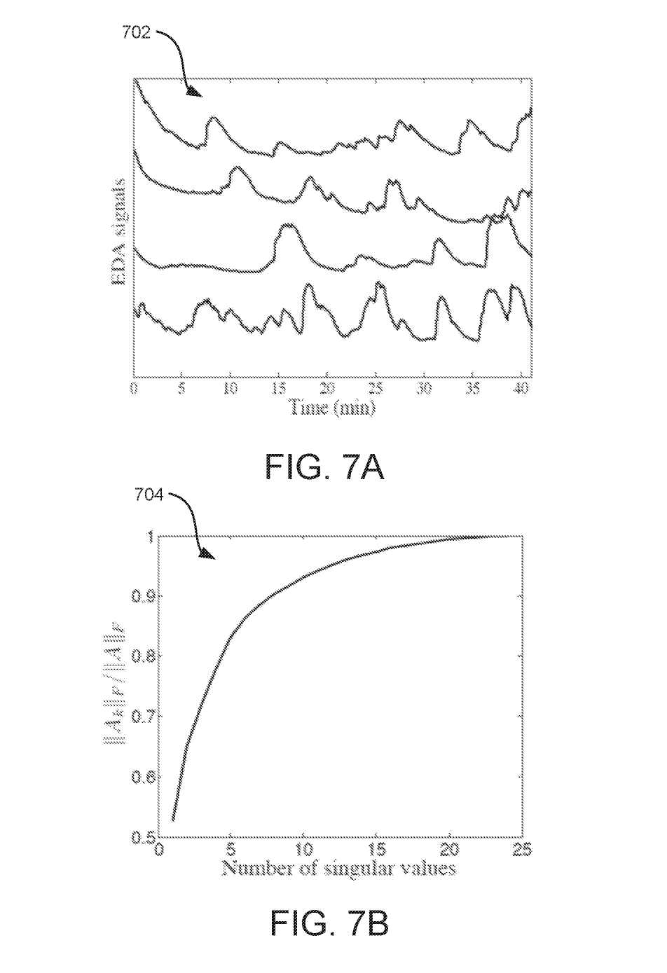

Referring to FIG. 7A, plot 702 is shown, where plot 702 includes the EDA traces corresponding to four users. To demonstrate the low rank nature of the data, in FIG. 7B, plot 704 is shown, where plot 704 plots the Frobenius norm of A covered by Aₖ is as a function of k. It is to be appreciated that, for this data, only 5 singular vectors are needed to capture 80% of the total Frobenius norm of the complete matrix. Plots 702 and 704 show that a low-rank approximation of the EDA traces will fit to the observed data accurately.

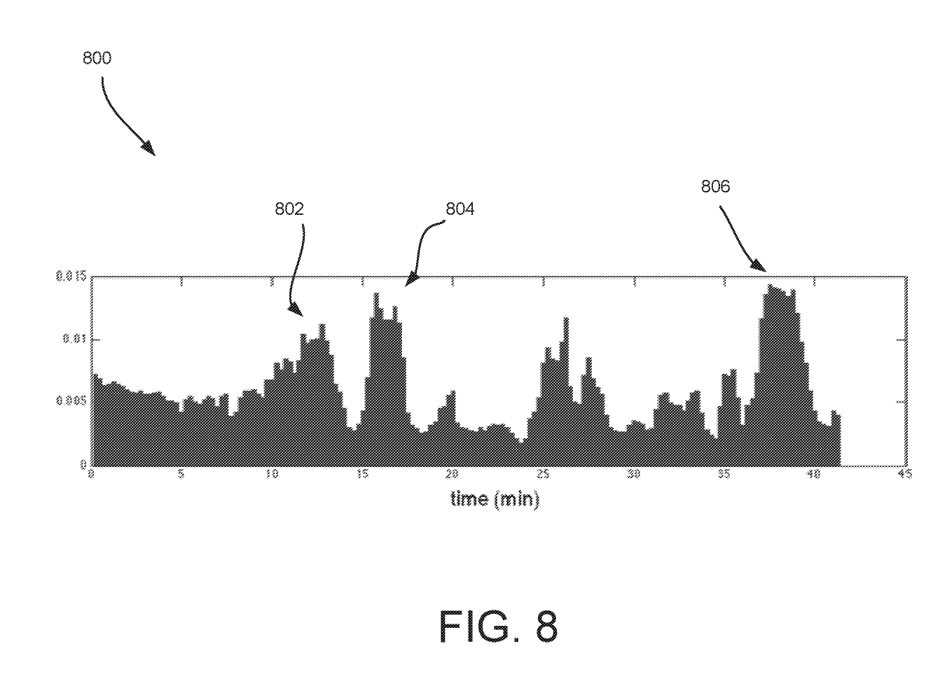

Next, the columns of this matrix are segmented into blocks (i.e., groups of columns as described above) such that s=15 seconds. In FIG. 8 the computed block leverage scores of all 24 users (i.e., m) is shown in accordance with the present disclosure. As seen in FIG. 8, the block leverage scores seem to suggest that certain segments are more important than others. For example, the highest block block leverage scores occur around the 12, 26, and 38 minute marks of the show, where the segment corresponding to the 12 minute mark is referenced in FIG. 8 by reference number 802, the segment corresponding to the 26 minute mark is referenced by reference number 804, and the segment corresponding to the 38 minute mark is referenced by reference number 806 in FIG. 8. It is to be appreciated that segment 802 corresponds to a segment of the show including a dead body, segment 804 corresponds to a segment of the show including the unveiling of a clue to solving the mystery, and segment 806 corresponds to a segment of the show including the final arrest, respectively.

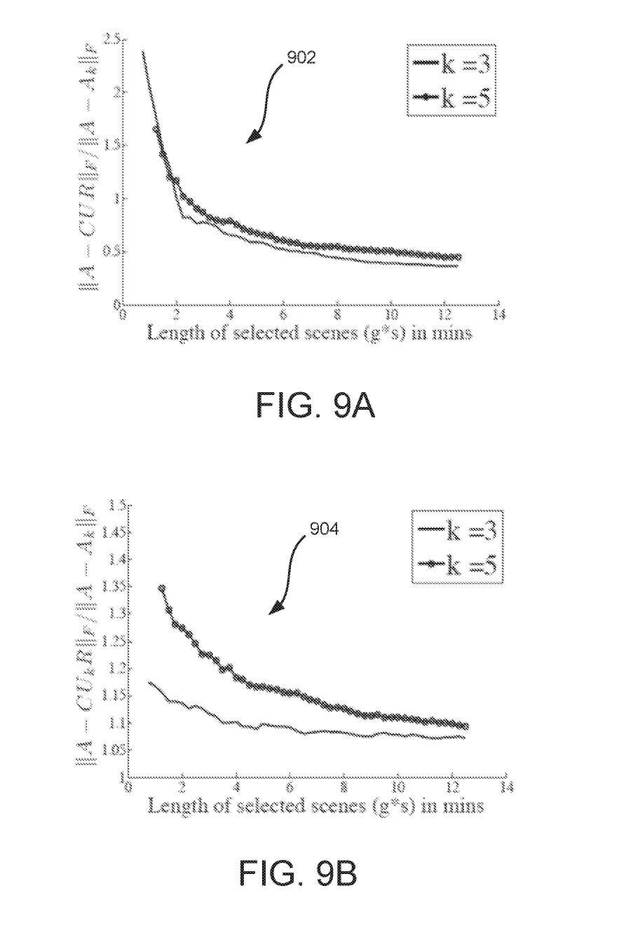

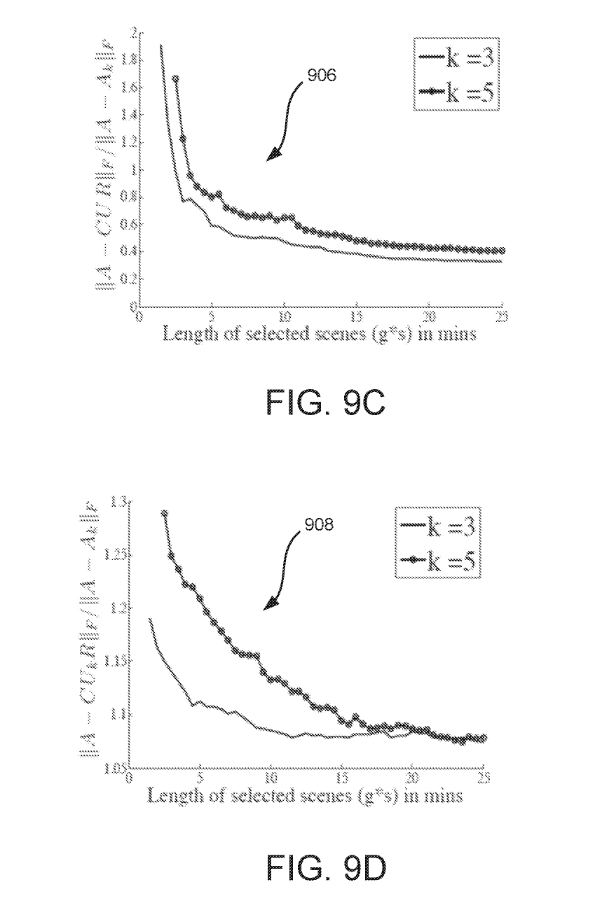

Using Algorithm 2 (i.e., method 600), the EDA traces (rows) of 20 users (i.e., group r) are uniformly sampled and the EDA traces of 4 users (i.e., group m-r) are held out. Then, the column blocks associated with the segments of the show with the highest block leverage scores (i.e., segment 802, 804, and 806) were sampled and the resulting error in Frobenius norm was plotted. The normalized Frobenius norm error of the approximation is shown in FIG. 9A, FIG. 9B, FIG. 9C and FIG. 9D, in accordance with the present disclosure. FIG. 9A, FIG. 9B, FIG. 9C and FIG. 9D include plots 902, 904, 906, and 908, respectively. Plots 902, 904, 906, and 908 show the normalized Frobenius norm error of the Block CUR approximation as a function of the number of blocks, g, sampled. More precisely, the ratio ∥A−CUR∥_{F}/∥A−Aₖ∥_{F} and ∥A−CUₖR∥_{F}/∥A−Aₖ∥_{F} are plotted for two values of the target rank, k=3 and 5 and two values of block size, s=60 (i.e., plots 902 and 906) and 120 (i.e., plots 904 and 908) columns per block (15 and 30 seconds), respectively. Plots 902, 904, 906, and 908, show how close the Block CUR approximation of the EDA traces of the 4 users get to the original matrix with respect to the number of segments shown to the users. As seen in FIG. 8, as the length of the selected segments (i.e., the segments of the show corresponding to 802, 804, and 806) was increased, the accuracy of the approximation increased. It is to be appreciated that in the experiment, algorithm 2 was repeated multiple times and plot the mean values of the normalized error over 10 trials. Furthermore, it is to be appreciated that plots 902, 904, 906, and 908 were generated using sampling without replacement even though the present disclosure supports sampling with replacement since sampling the same blocks is inefficient in practice.

It is to be appreciated that plots 902, 904, 906 and 908 show the interplay between the number of blocks sampled and the issue of context which is related to block size, as described above in the present disclosure. To give the viewer some context, the length of the segment is chosen so that the segment is long enough to provide context, while on the other hand, sufficiently short to reduce the cost and time of obtaining the data. These conflicting aims result in a trade-off of block size and the number of blocks sampled. For example, for k=5, the normalized error is less than one when a 2.5 minute long clipping is shown to the viewer, that is g=10 with block size s=15 seconds (or 60 columns), whereas the normalized error is less than one when a 3.5 minute long clipping is shown to the viewer (g=7) with block size s=30 seconds (or 120 columns). These results demonstrate the practical use of the Block CUR algorithm.

In the present disclosure, the step of receiving associated with flowcharts 500, 600 and 650 can imply receiving, accessing or retrieving. The step of providing associated with flowchart 500, 600 and 650 can imply outputting, transmitting or storing in memory for later access or retrieval.

In addition, the principles of the present disclosure can be implemented in various forms of hardware, software, firmware, special purpose processors, or a combination thereof. The present disclosure can be implemented as a combination of hardware and software. Moreover, the software can be implemented as an application program tangibly embodied on a program storage device. The application program can be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein can either be part of the microinstruction code or part of the application program (or a combination thereof), which is executed via the operating system. In addition, various other peripheral devices can be connected to the computer platform such as an additional data storage device and a printing device.

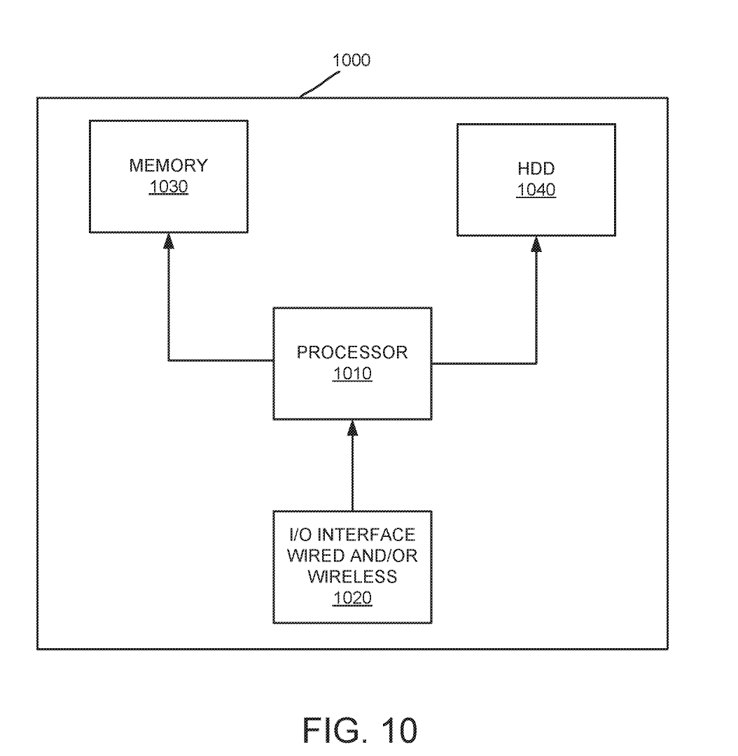

FIG. 10 shows a block diagram of a computing environment 1000 within which any of the methods or apparatuses of the present disclosure can be implemented and executed. The computing environment 1000 includes a processor 1010, and at least one I/O interface 1020. The I/O interface 1020 can be wired or wireless and, in the wireless implementation is pre-configured with the appropriate wireless communication protocols to allow the computing environment 1000 to operate on a global network (e.g., internet) and communicate with other computers or servers (e.g., cloud based computing or storage servers) so as to enable the present disclosure to be provided, for example, as a Software as a Service (SAAS) feature remotely provided to end users. One or more memories 1030 and/or storage devices (Hard Disk Drives (HDD)) 1040 are also provided within the computing environment 1000. The computing environment can be used to implement a node or device, and/or a controller or server who operates the storage system. The computer environment can implement any of the described embodiments of biometric response analyzer 250.

Furthermore, aspects of the present disclosure can take the form of a computer-readable storage medium. Any combination of one or more computer-readable storage medium(s) can be utilized. A computer-readable storage medium can take the form of a computer-readable program product embodied in one or more computer-readable medium(s) and having computer-readable program code embodied thereon that is executable by a computer. A computer-readable storage medium as used herein is considered a non-transitory storage medium given the inherent capability to store the information therein as well as the inherent capability to provide retrieval of the information therefrom. A computer-readable storage medium can be, for example, but is not limited to, an electronic, magnetic, optical, electromagnetic, infrared, or semiconductor system, apparatus, or device, or any suitable combination of the foregoing.

It is to be appreciated that the following list, while providing more specific examples of computer-readable storage mediums to which the present disclosure can be applied, is merely an illustrative and not exhaustive listing as is readily appreciated by one of ordinary skill in the art. The list of examples includes a portable computer diskette, a hard disk, a read-only memory (ROM), an erasable programmable read-only memory (EPROM or Flash memory), a portable compact disc read-only memory (CD-ROM), an optical storage device, a magnetic storage device, or any suitable combination of the foregoing.

According to one aspect of the present disclosure, a method of generating a summary of a digital multimedia content is provided including receiving a plurality of biometric responses to the digital multimedia content for a plurality of users, the digital multimedia content including a plurality of samples, each biometric response in the plurality of biometric responses corresponding to a sample of the digital multimedia content and a user of the plurality of users, determining segment scores associated to a plurality of segments of the digital multimedia content based on the biometric responses of the plurality of users to corresponding segments, each segment corresponding to a subset of consecutive samples of the digital multimedia content, randomly selecting a number of segments based on the determined segment scores, and generating a summary of the digital multimedia content including the selected segments.

According to one embodiment of the method, the randomly selecting further includes determining a probability for each segment based on each segment's respective determined segment score, and randomly selecting the number of segments according to the probability determined for each segment.

According to one embodiment of the method, the determined probability for each segment is proportional to the determined segment score of the corresponding segment.

According to one embodiment of the method, the determined probability is a ratio between the segment score of the corresponding segment and the number of users in the plurality of users.

According to one embodiment of the method, the randomly selecting further includes randomly selecting a given segment of the digital multimedia content only once.

According to one embodiment of the method, each determined segment score is a block leverage score, the block leverage score being the sum of the energy in the principal components of the biometric responses corresponding to the segment of the digital multimedia content.

According to one embodiment of the method, each determined segment score is the sum of the energy of the biometric responses corresponding to a segment.

According to one embodiment of the method, the digital multimedia content includes video content.

According to one embodiment of the method, the digital multimedia content includes audio content.

According to one embodiment of the method, at least one segment of the digital multimedia content is smaller than a scene of the digital multimedia content.

According to one embodiment of the method, each selected segment has the same duration of time.

According to one embodiment of the method, the plurality of biometric responses forms a matrix, each row of the matrix corresponding to one user of the plurality of users and each column of the matrix corresponding to a sample of the digital multimedia content.

According to one embodiment of the method, the biometric response is a galvanic skin response.

According to one embodiment of the method, generating further includes ordering the selected segments in the same order in which they appear in the digital multimedia content.

According to one embodiment of the method, the method further includes providing the summary of the digital multimedia content.

According to one aspect of the present disclosure, an apparatus for generating a summary of a digital multimedia content is provided, the apparatus including a processor in communication with at least one input/output interface, and at least one memory in communication with the processor, the processor being configured to perform any of the embodiments of the method of generating a summary of a digital multimedia content.

According to one aspect of the present disclosure, a computer-readable storage medium carrying a software program is provided including program code instructions for performing any of the embodiments of the method of generating a summary of a digital multimedia content.

According to one aspect of the present disclosure, a non-transitory computer-readable program product is provided including program code instructions for performing any of the embodiments of the method of generating a summary of a digital multimedia content.

According to one aspect of the present disclosure, a method of extrapolating user biometric responses to digital multimedia content is provided including receiving a first set of biometric responses to the digital multimedia content for a first group of users, the digital multimedia content including a plurality of samples, each biometric response in the first set of biometric responses corresponding to a sample of the digital multimedia content and a user of the first group of users, receiving a second set of biometric responses to a summary of the digital multimedia content for a second group of users, the summary of the digital multimedia content including a plurality of segments of the digital multimedia content, each segment corresponding to a subset of consecutive samples of the digital multimedia content, each biometric response of the second set of biometric responses corresponding to a sample in a segment of the summary of the digital multimedia content, and extrapolating biometric responses of the second group of users to the digital multimedia content based on the first set of biometric responses and the second set of biometric responses, the extrapolated biometric responses being other than the biometric responses in the second set.

According to one embodiment of the method, the method further includes extracting the biometric responses in the first set of biometric responses that correspond to the segments of the digital multimedia content in the summary of the digital multimedia content.

According to one embodiment of the method, the first set of biometric responses forms a first matrix, each row of the first matrix corresponding to one user of the first group of users and each column of the first matrix corresponding to a sample of the digital multimedia content, the extracted biometric responses in the first set of biometric responses and the biometric responses in the second set of biometric responses form a second matrix, each row of the second matrix corresponding to one user of the first or second group of users and each column of the second matrix corresponding to a sample of the summary of the digital multimedia content, and the intersection of the first and second matrices forms a third matrix, each row of the third matrix corresponding to one user of the first group of users and each column of the second matrix corresponding to a sample of the summary of the digital multimedia content.

According to one embodiment of the method, the method further includes determining a pseudoinverse of the third matrix.

According to one embodiment of the method, the extrapolating further includes determining a product of the second matrix, the pseudoinverse of the third matrix, and the first matrix, respectively.

According to one embodiment of the method, the method further includes providing the extrapolated biometric responses.

According to one embodiment of the method, the digital multimedia content includes video content.

According to one embodiment of the method, the digital multimedia content includes audio content.

According to one embodiment of the method, at least one segment of the digital multimedia content is shorter in time duration than a scene of the digital multimedia content.

According to one embodiment of the method, every segment of the digital multimedia content has the same time duration.

According to one embodiment of the method, the summary is generated by randomly selecting the segments based on segment scores determined from the biometric responses of the second set of biometric responses associated with the segments.

According to one aspect of the present disclosure, an apparatus for extrapolating user biometric responses to digital multimedia content is provided, the apparatus including a processor (1010) in communication with at least one input/output interface, and at least one memory (1030, 1040) in communication with the processor, the processor being configured to perform any of the embodiments of the method of extrapolating user biometric responses to digital multimedia content.

According to one aspect of the present disclosure, a computer-readable storage medium carrying a software program is provided including program code instructions for performing any of the embodiments of the method of extrapolating user biometric responses to digital multimedia content.

According to one aspect of the present disclosure, a non-transitory computer-readable program product is provided including program code instructions for performing any of the embodiments of the method of extrapolating user biometric responses to digital multimedia content.

According to one aspect of the present disclosure, a method of providing a recommendation is provided including receiving a set of biometric responses to digital multimedia content for at least one user including extrapolated biometric responses generated according to any of the embodiments of the method of extrapolating user biometric responses to digital multimedia content, generating a recommendation based on the biometric responses, and providing the recommendation.

According to one embodiment of the method, the generating further includes determining a recommendation score based on the set of biometric responses, and determining a recommendation based on the recommendation score.

According to one embodiment of the method, the determining a recommendation score further includes determining a sum of the energy of the biometric responses of the at least one user to at least one segment in the digital multimedia content.

According to one embodiment of the method, the determining a recommendation further includes determining that the at least one segment is exciting if the recommendation score is above a content threshold and that the at least one segment is not exciting if the recommendation score is below the content threshold.

According to one embodiment of the method, the determining a recommendation further includes determining that the at least one user is excitable if the recommendation score is above a user threshold and that the at least one user is not excitable if the recommendation score is below the user threshold.

According to one embodiment of the method, the generating a recommendation further includes determining a rating for the digital multimedia content based on whether the at least one segment is exciting, wherein the rating is the recommendation.

According to one embodiment of the method, the generating a recommendation further includes determining at least one product to recommend to the one user based on whether the one user is excitable, wherein the at least one product is the recommendation.

According to one embodiment of the method, the generating a recommendation further includes determining at least one product to recommend to one user based on whether the one user has similar biometric responses to other users, wherein the at least one product is the recommendation.

According to one aspect of the present disclosure, an apparatus for providing a recommendation is provided, the apparatus including a processor in communication with at least one input/output interface, and at least one memory in communication with the processor, the processor being configured to perform any of the embodiments of the method of providing a recommendation.

According to one aspect of the present disclosure, a computer-readable storage medium carrying a software program is provided including program code instructions for performing any of the embodiments of the method of providing a recommendation.

According to one aspect of the present disclosure, a non-transitory computer-readable program product is provided including program code instructions for performing any of the embodiments of the method of providing a recommendation.

It is to be further understood that, because some of the constituent system components and methods depicted in the accompanying drawings are preferably implemented in software, the actual connections between the system components or the process function blocks can differ depending upon the manner in which the present disclosure is programmed. Given the teachings herein, one of ordinary skill in the pertinent art will be able to contemplate these and similar implementations or configurations of the present disclosure.

Although the illustrative embodiments have been described herein with reference to the accompanying drawings, it is to be understood that the present disclosure is not limited to those precise embodiments, and that various changes and modifications can be effected therein by one of ordinary skill in the pertinent art without departing from the scope of the present disclosure. In addition, individual embodiments can be combined, without departing from the scope of the present disclosure. All such changes and modifications are intended to be included within the scope of the present disclosure as set forth in the appended claims.

1. A method of extrapolating user biometric responses to digital multimedia content comprising:
receiving a first set of biometric responses to the digital multimedia content for a first group of users, the digital multimedia content comprising a plurality of samples, each biometric response in the first set of biometric responses corresponding to a sample of the digital multimedia content and a user of the first group of users;
receiving a second set of biometric responses to a summary of the digital multimedia content for a second group of users, the summary of the digital multimedia content comprising a plurality of segments of the digital multimedia content, each segment corresponding to a subset of consecutive samples of the digital multimedia content, each biometric response of the second set of biometric responses corresponding to a sample in a segment of the summary of the digital multimedia content; and
extrapolating biometric responses of the second group of users to the digital multimedia content based on the first set of biometric responses and the second set of biometric responses, said extrapolated biometric responses being other than the biometric responses in the second set.

2. The method of claim 1 further comprising:
extracting the biometric responses in the first set of biometric responses that correspond to the segments of the digital multimedia content in the summary of the digital multimedia content.

3. The method of claim 2 wherein the first set of biometric responses forms a first matrix, each row of the first matrix corresponding to one user of the first group of users and each column of the first matrix corresponding to a sample of the digital multimedia content, the extracted biometric responses in the first set of biometric responses and the biometric responses in the second set of biometric responses form a second matrix, each row of the second matrix corresponding to one user of the first or second group of users and each column of the second matrix corresponding to a sample of the summary of the digital multimedia content, and the intersection of the first and second matrices forms a third matrix, each row of the third matrix corresponding to one user of the first group of users and each column of the second matrix corresponding to a sample of the summary of the digital multimedia content.

4. The method of claim 3 further comprising:
determining a pseudoinverse of the third matrix.

5. The method of claim 4 wherein the extrapolating further comprises:
determining a product of the second matrix, the pseudoinverse of the third matrix, and the first matrix, respectively.

6. The method of claim 1 further comprising:
providing said extrapolated biometric responses.

7. The method of claim 1 wherein the digital multimedia content comprises video content.

8. The method of claim 1 wherein the digital multimedia content comprises audio content.

9. The method of claim 1 wherein at least one segment of the digital multimedia content is shorter in time duration than a scene of the digital multimedia content.

10. The method of claim 1 wherein every segment of the digital multimedia content has the same time duration.

11. The method of claim 1 wherein said summary is generated by randomly selecting said segments based on segment scores determined from the biometric responses of said second set of biometric responses associated with said segments.

12. An apparatus for extrapolating user biometric responses to digital multimedia content, the apparatus comprising:
a processor; and
at least one memory in communication with the processor, the processor being configured to:
receive a first set of biometric responses to the digital multimedia content for a first group of users, the digital multimedia content comprising a plurality of samples, each biometric response in the first set of biometric responses corresponding to a sample of the digital multimedia content and a user of the first group of users;
receive a second set of biometric responses to a summary of the digital multimedia content for a second group of users, the summary of the digital multimedia content comprising a plurality of segments of the digital multimedia content, each segment corresponding to a subset of consecutive samples of the digital multimedia content, each biometric response of the second set of biometric responses corresponding to a sample in a segment of the summary of the digital multimedia content; and
extrapolate biometric responses of the second group of users to the digital multimedia content based on the first set of biometric responses and the second set of biometric responses, said extrapolated biometric responses being other than the biometric responses in the second set.

13. The apparatus of claim 12 wherein the processor is further configured to:
extract the biometric responses in the first set of biometric responses that correspond to the segments of the digital multimedia content in the summary of the digital multimedia content.

14. The apparatus of claim 13 wherein the first set of biometric responses forms a first matrix, each row of the first matrix corresponding to one user of the first group of users and each column of the first matrix corresponding to a sample of the digital multimedia content, the extracted biometric responses in the first set of biometric responses and the biometric responses in the second set of biometric responses form a second matrix, each row of the second matrix corresponding to one user of the first or second group of users and each column of the second matrix corresponding to a sample of the summary of the digital multimedia content, and the intersection of the first and second matrices form a third matrix, each row of the third matrix corresponding to one user of the first group of users and each column of the second matrix corresponding to a sample of the summary of the digital multimedia content.

15. The apparatus of claim 14 wherein the processor is further configured to extrapolate biometric responses of the second group of users by determining a pseudoinverse of the third matrix.

16. The apparatus of claim 15 wherein the processor is further configured to extrapolate biometric responses of the second group of users by determining a product of the second matrix, the pseudoinverse of the third matrix, and the first matrix, respectively.

17. The apparatus of claim 12 wherein the processor is further configured to:
provide said extrapolated biometric responses.

18. The apparatus of claim 12 wherein the digital multimedia content comprises video content.

19. The apparatus of claim 12 wherein the digital multimedia content comprises audio content.

20. The apparatus of claim 12 wherein at least one segment of the digital multimedia content is shorter in time duration than a scene of the digital multimedia content.

21-38. (canceled)
